(19) United States
(12) Patent Application Publication
(10) Pub. No.: US 2022/0275137 A1
(43) Pub. Date: Sep. 1, 2022

(54) TUNING PROTEIN SOLUBILITY BY POLYMER SURFACE MODIFICATION

(71) Applicant: Carnegie Mellon University, Pittsburgh, PA (US)

(72) Inventors: Alan J. Russell, Pittsburgh, PA (US); Stefanie L. Baker, Pittsburgh, PA (US)

(21) Appl. No.: 17/631,985

(22) PCT Filed: Jul. 31, 2020
(86) PCT No.: PCT/US2020/044581

§ 371 Date: Feb. 1, 2022

Related U.S. Application Data
(60) Provisional application No. 62/922,294, filed on Aug. 1, 2019.

(51) Int. Cl. C08F 293/00; C08F 4/40

(52) U.S. Cl. CPC C08F 293/005; C08F 4/40; C08F 2438/01; C08F 2438/03

(57) ABSTRACT

Materials and methods for protein purification, and particularly for protein purification by ammonium sulfate precipitation, are provided herein.

### CROSS-REFERENCE TO RELATED APPLICATIONS

This application claims benefit of priority from U.S. Application Ser. No. 62/922,294, filed on Aug. 1, 2019, the disclosure of which is considered part of (and is incorporated by reference in) the disclosure of this application.

### TECHNICAL FIELD

This document relates to materials and methods for protein purification, and more particularly to materials and methods for protein purification using saturated salt solutions (e.g., saturated ammonium sulfate solutions).

### BACKGROUND

Protein-polymer conjugates are synthesized from pure starting materials, but separating the conjugates from the starting polymer and native protein and from isomers is a major challenge that has vexed scientists for decades. Commercial proteins typically are purified using ammonium sulfate precipitation. Purification of proteins in biotechnology has been achieved by chromatography, but this can account for 30 to 50% of the manufacturing cost for high-value biopharmaceuticals.

Purification via precipitation has historically been used for fractionation of biomolecules from blood plasma, but it is becoming increasingly prevalent for other therapeutic biologics (Martinez et al., Trends Biotechnol. 37:237-241, 2019), such as unmodified and polyethylene glycol- (PEG-) modified therapeutic antibodies. Thus, there is increasing demand for more efficient, simple, cost effective, and scalable protein purification methods.

### SUMMARY

This document is based, at least in part, on the discovery that covalent polymer attachment to proteins can have a transformational effect on protein solubility in salt solutions. As described herein, protein-polymer conjugates with a variety of polymers, grafting densities, and polymer lengths were generated using atom transfer radical polymerization (ATRP). Charged polymers increased conjugate solubility in ammonium sulfate and completely prevented precipitation even at 100% saturation. Atomistic molecular dynamic simulations showed that the impact was driven by an anti-polyelectrolyte effect from zwitterionic polymers. Uncharged polymers exhibited polymer length-dependent decreased solubility. The differences in salting-out can be used to simply purify mixtures of conjugates and native proteins into single species. The methods described herein for increasing protein solubility in salt solutions through polymer conjugation may lead to many new applications of protein-polymer conjugates.

In a first aspect, this document features a protein-polymer conjugate, where the conjugate includes a protein having one or more polymer chains attached thereto, where the polymer is a charged, zwitterionic, or polyelectrolyte polymer, and where the protein-polymer conjugate is soluble in saturated ammonium sulfate. The polymer can be a charged polymer, a zwitterionic polymer, or a polyelectrolyte polymer. The saturated ammonium sulfate can contain ammonium sulfate at a concentration of about 4.0 to about 4.5 M. The conjugate can have a grafting density of 1 to 30 polymer chains per protein molecule. The polymer can include from two to 500 monomer units. The protein can retain function at a level that is at least 50% of the level of function when the protein is not conjugated to the polymer.

In another aspect, this document features a saturated ammonium sulfate solution having a protein-polymer conjugate dissolved therein, where the conjugate includes a protein having one or more polymer chains attached thereto, and where the polymer is a charged, zwitterionic, or polyelectrolyte polymer. The polymer can be a charged, zwitterionic, or polyelectrolyte polymer. The solution can contain ammonium sulfate at a concentration of about 4.0 to about 4.5 M. The conjugate can be present in the solution at a concentration of about 0.1 mg/mL to about to 100 mg/mL.

In another aspect, this document features a method for engineering the solubility of a protein. The method can include selecting a polymer likely to confer high or low solubility in a saturated ammonium sulfate solution, where the polymer is a charged, zwitterionic, or polyelectrolyte polymer selected to confer high solubility in saturated ammonium sulfate or wherein the polymer is an uncharged polymer selected to confer low solubility in saturated ammonium sulfate, and generating one or more chains of the selected polymer on the protein. In some cases, the polymer can be a charged polymer. In some cases, the polymer can be a zwitterionic polymer. In some cases, the polymer can be a polyelectrolyte polymer. In some cases, the polymer can be an uncharged polymer selected from the group consisting of poly(oligo(ethylene glycol) methacrylate) (pOEGMA), polyethylene glycol (PEG), pDMAEMA (polydimethylamino ethyl methacrylate), polyacrylamide, and polyvinyl pyrrolidone. The saturated ammonium sulfate solution can contain ammonium sulfate at a concentration of about 4.0 to about 4.5 M. The conjugate can have a grafting density of 1 to 5 polymer chains per protein molecule. Each chain of the selected polymer generated on the protein can have from two to 500 monomer units. The generating step can include atom transfer radical polymerization (ATRP) or reversible addition fragmentation chain-transfer (RAFT) polymerization.

In another aspect, this document features a method for generating a protein-polymer conjugate. The method can include selecting a polymer likely to confer high or low solubility to the protein in saturated ammonium sulfate, generating one or more chains of the selected polymer on the protein to yield the protein-polymer conjugate, and placing the protein-polymer conjugate in a saturated ammonium sulfate solution. The polymer can be a charged polymer, a zwitterionic polymer, or a polyelectrolyte polymer. The polymer can be an uncharged polymer. The saturated ammonium sulfate solution can contain ammonium sulfate at a concentration of about 4.0 to about 4.5 M. The conjugate can have a grafting density of 1 to 5 polymer chains per protein molecule. Each chain of the selected polymer generated on the protein can have from two to 500 monomer units. The generating step can include ATRP or RAFT.

In another aspect, this document features a method for purifying a protein-polymer conjugate. The method can include combining (i) a composition containing the conjugate and (ii) ammonium sulfate, to generate a saturated ammonium sulfate solution and yield a precipitate and a supernatant, where the protein-polymer conjugate is within the supernatant, and separating the supernatant from the precipitate, where the conjugate includes a charged, zwitterionic, or polyelectrolyte polymer that confers solubility to the protein in the saturated ammonium sulfate solution. The polymer can be a charged polymer, a zwitterionic polymer, or a polyelectrolyte polymer. The saturated ammonium sulfate solution can contain ammonium sulfate at a concentration of about 4.0 to about 4.5 M. The conjugate can have a grafting density of 1 to 5 polymer chains per protein molecule. Each chain of the selected polymer on the protein can have from two to 500 monomer units.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram depicting representative steps in grafting-from Lyz-polymer conjugate synthesis using ATRP. A positively charged ATRP initiator was first reacted with accessible amino groups on the Lyz surface (top). Next, ATRP was used to grow polymers of zwitterionic CBMA or neutral OEGMA at increasing polymer lengths (bottom). NaAsc, sodium ascorbate; HMTETA, 1,1,4,7,10,10-Hexamethyltriethylenetetramine.

FIG. 2 depicts a pair of MALDI-ToF spectra for native Lyz (top) and Lyz-initiator (bottom). The number of attached initiators was calculated by the difference in m/z between Lyz-initiator and native Lyz divided by the mass of the initiator (321 Da). The average number of attached initiators was 4.8.

FIG. 3 depicts a graph plotting dynamic light scattering hydrodynamic diameters, by number distribution, for Lyz(5+)pCBMA (diamonds) and Lyz(5+)pOEGMA (squares) conjugates of increasing polymer length (DP).

FIG. 4 depicts gel permeation chromatography spectra of cleaved pCBMA from conjugates. Polymers were cleaved by acid hydrolysis (6N HCl) at 110° C. under vacuum overnight and then dialyzed in deionized water. Polymers increased in molecular mass as DP increased. DP 18 (diamond), DP 32 (cross), DP 56 (square), DP 79 (circle), DP 91 (triangle).

FIG. 5 depicts gel permeation chromatography spectra of cleaved pOEGMA from conjugates. Polymers were cleaved by acid hydrolysis (6N HC1) at 110° C. under vacuum overnight and then dialyzed in deionized water. Polymers increased in molecular mass as DP increased. DP 25 (diamond), DP 43 (cross), DP 90 (square), DP 105 (circle), DP 164 (triangle).

FIGS. 6A and 6B depict graphs plotting solubility (log supernatant protein concentration) vs. ammonium sulfate percent saturation for ammonium sulfate precipitation of native Lyz, Lyz(5+), and Lyz-polymer conjugates. 100% saturation corresponds to 4.1 M salt concentration. FIG. 6A shows results for Lyz(5+)pCBMA conjugates with DP 18, DP 32, DP 56, DP 79, and DP 91. FIG. 6B shows results for Lyz(5+)pOEGMA conjugates with DP 25, DP 43, DP 90, DP 105, and DP 164. pCBMA increased the solubility of Lyz, while pOEGMA decreased the solubility of Lyz depending on DP. FIGS. 6C and 6D are graphs plotting solubility vs. ammonium sulfate percent saturation for ammonium sulfate precipitation of native Lyz(1+), Lyz(3+), and Lyz-polymer conjugates with lower grafting densities and low/high DP. FIG. 6C shows results for pCBMA conjugates of Lyz(1+) DP 14, Lyz(1+) DP 44, Lyz(3+) DP 20, and Lyz(3+) DP 66. The only pCBMA conjugate that precipitated was the lowest grafting density and lowest DP. FIG. 6D shows results for pOEGMA conjugates of Lyz(1+) DP 9, Lyz(1+) DP 93, Lyz(3+) DP 16, and Lyz(3+) DP 57. pOEGMA length affected solubility more than grafting density. Error bars represent the standard deviations from triplicate measurements (n=3).

FIG. 7 depicts a graph plotting ammonium sulfate precipitation of free native Lyz in solution with free pCBMA (circles) or pOEGMA (diamonds). The amount of free polymer added was the same amount of polymer that was present in the Lyz-pCBMA DP 91 or Lyz-pOEGMA DP 164 samples during the conjugate ammonium sulfate precipitation experiment.

FIG. 8 depicts gel permeation chromatography spectra of free pCBMA (circle) and pOEGMA (triangle).

FIG. 9A-9C depict MALDI-ToF spectra of native Lyz (FIG. 9A), Lyz(1+) (FIG. 9B), and Lyz(3+) (FIG. 9C).

FIGS. 10A and 10B depict graphs plotting the results of studies using dynamic light scattering data to measure hydrodynamic diameters. FIG. 10A shows results for Lyz(5+)pCBMA conjugates in increasing ammonium sulfate saturation for DP 18, DP 32, DP 56, DP 79, and DP 91. All conjugates increased in hydrodynamic diameter with increased ammonium sulfate concentration. Native Lyz and Lyz(5+) hydrodynamic diameters were not able to be measured after 50% saturation because samples precipitated. FIG. 10B shows results for Lyz(5+)pCBMA DP 18 and DP 91 hydrodynamic diameter stability over 2.5 months in 100% saturated ammonium sulfate. Data are presented as number distribution averages ±1 standard deviation errors from n=3 measurements).

FIGS. 11A and 11B depict graphs plotting hydrodynamic diameters (number distribution averages and errors) of Lyz(5+)pCBMA DP 91 in (FIG. 11A) increasing (squares) or decreasing (circles) ammonium sulfate concentrations, and (FIG. 11B) cycling between 50% (circles) and 100% saturation (triangles) over three complete cycles. These data showed that the change in hydrodynamic diameter with ammonium sulfate concentration is reversible.

FIGS. 12A-12D depict graphs plotting hydrodynamic diameters in 100% ammonium sulfate saturation of Lyz(5+)pCBMA DP 18 by number distribution (FIG. 12A) and volume distribution (FIG. 12B) and DP 91 by number distribution (FIG. 12C) and volume distribution (FIG. 12D) after storage for 2.5 months. Multimodal peaks are present in volume distributions indicating micro-aggregation.

FIGS. 13A-13F depict graphs plotting enzymatic reaction rates of Lyz-pCBMA conjugates in 50 mM NaPhos buffer (pH 6.0) (FIGS. 13A, 13C, and 13E) and 100% saturated ammonium sulfate (pH 5.5) (FIGS. 13B, 13D, and 13F). Graphs are shown for conjugates with five initiators in NaPhos (FIG. 13A) and 100% ammonium sulfate (FIG. 13B) for native Lyz (squares), Lyz(5+) (triangles), DP 18 (diamonds), DP 32 (inverted triangles), DP 56 (crosses), DP 79 (open circles), and DP 91 (vertical lines). Graphs are shown for conjugates with three initiators in NaPhos (FIG. 13C) and 100% ammonium sulfate (FIG. 13D) for native Lyz (squares), Lyz(3+) (triangles), DP 20 (diamonds), and DP 66 (inverted triangles). Graphs are shown for conjugates with one initiator in NaPhos (FIG. 13E) and 100% ammonium sulfate (FIG. 13F) for native Lyz (squares), Lyz(1+) (triangles), DP 14 (diamonds), and DP 44 (inverted triangles). Blanks from auto hydrolysis of substrate are shown in NaPhos and 100% ammonium sulfate (filled circles) in FIG. 13A and FIG. 13B, respectively.

FIGS. 14A and 14B depict images of gels showing purification of conjugates using SDS-PAGE analysis. In particular, the silver stained SDS-PAGE gels show purification of a mixture of native Lyz and Lyz(5+)pCBMA DP 91 (FIG. 14A) or Lyz(5+)pOEGMA DP 164 (FIG. 14B). Samples were mixed in a 1 to 99 volume ratio of native Lyz to conjugate (starting mix) and ammonium sulfate was added to preferentially precipitate native Lyz from Lyz-pCBMA (100% saturation) or to precipitate Lyz-pOEGMA from native Lyz (40% saturation). Supernatants and precipitates were dialyzed in deionized water to remove salt and were then concentrated back to starting concentrations using ultrafiltration prior to SDS-PAGE analysis.

FIG. 15 shows a silver stained SDS-PAGE analysis from a second round of purification of Lyz(5+)pCBMA DP 91 from a mixture with native Lyz. The supernatant from FIG. 14A was purified again by the addition of 100% saturated ammonium sulfate and the same processing was performed as in FIG. 14A. No native Lyz remained in the supernatant after the second purification.

FIG. 16A depicts a graph plotting ammonium sulfate precipitation of native CT, CT-neutral initiator, and CT-polymer conjugates. Native CT (filled circles), CT-neutral initiator (triangles), CT-pCBMA DP 112 (diamonds), CT-pOEGMA DP 97 (inverted triangles), CT-pDMAEMA DP 89 (crosses), CT-pQA DP 89 (squares), and CT-pSMA DP 113 (open circles). Error bars (present within the symbols) represent the standard deviations from triplicate measurements. FIG. 16B shows the various structures of charged polymers that were grown from CT using the neutral ATRP initiator.

### DETAILED DESCRIPTION

Covalently attaching synthetic polymers (e.g., PEG) to proteins can alter the bioactivity (Lele et al., Biomacromolecules 6:3380-3387, 2005), stability (Baker et al., Biomacromolecules 19:3798-3813, 2018), circulating half-life (Abuchowski et al., J. Biol. Chem. 252:3582-3586, 1977), and immunogenicity (Abuchowski et al., supra) of the protein in the resulting protein-polymer conjugates. The polymer attachment sites (Russell et al., AIChE 64:3230-3246, 2018), number of attachments (Carmali et al., Biomacromolecules 19:4044-4051, 2018; and Schulz et al., Adv. Mater. 28:1455-1460, 2016), polymer type (Baker et al., supra; and Lucius et al., Biomacromolecules 17:1123-1134, 2016), polymer chain length (Murata et al., Biomacromolecules 15:2817-2823, 2014; and Kaupbayeva et al., Biomacromolecules 20:1235-1245, 2019), and conjugation chemistry (Wilson, Macromol. Chem. Phys. 218:1600595, 2017; and Baker et al., Biomacromolecules 20:2392-2405, 2019) are all variables that can be tuned to optimize the conjugate's properties for a specific outcome, such as increased thermostability (Morgenstern et al., Int. J. Pharm. 519:408-417, 2017) or solubility.

Protein solubility can be especially important for therapeutic proteins, which may require concentrations as high as 100 mg/mL for effective dose administration. High concentrations of proteins can enhance aggregation-based degradation, however (Shire et al., J. Pharm. Sci. 93:1390-1402, 2004). Protein aggregation caused by poor solubility also has been linked to various disease states, including neurological diseases such as Parkinson's or Alzheimer's. In addition, a P23T (Pro23 to Thr) mutation in γD-crystallin can reduce solubility and cause early onset of cataracts (Evans et al., J. Mol. Biol. 343:435-444, 2004). In industrial biotechnology, enzyme solubility in non-aqueous media also is of particular interest, because new catalytic reactions can arise and become more efficient due to increased solubility of nonpolar substrates and products and/or reduction of unwanted hydrolytic side-reactions (Klibanov, Nature 409;241-246, 2001; Konieczny et al., J. Biotechnol. 181:55-63, 2014; Gupta, Eur. J. Biochem. 203:25-32, 1992; Ogino and Ishikawa, J. Biosci. Bioeng. 91:109-116, 2001; and Konieczny et al., J. Biotechnol. 159:195-203, 2012).

Protein solubility depends on numerous intrinsic and extrinsic factors. The intrinsic chemical structure of the protein surface and the number of charged amino acids can influence solubility (Kramer et al., Biophys. 1 102:1907-1915, 2012). In aqueous solutions, solubility is proportional to the number of charged amino acids on the protein surface. Interestingly, proteins are least soluble at their isoelectric point (pI) where they have no net charge. Thus, chemical modification of the protein surface can alter solubility. Indeed, PEGylation of proteins and other hydrophobic drugs can increase their solubility in water (Milla et al., Curr. Drug Metab. 13:105-119, 2012), while conjugation of poly(2-(dimethylamino)ethyl methacrylate (pDMAEMA) can facilitate the molecular dissolution of α-chymotrypsin in acetonitrile (Cummings et al., ACS Macro Lett. 5:493-497, 2016). More recently, pH-responsive polymers were conjugated to Protein-A to aid in the controlled precipitation of antibodies from cell culture supernatants (Anees et al., ACS Nano 13:1019-1028, 2019).

Extrinsic factors such as temperature, pH, ionic strength, and other additives also can impact solubility. It is difficult to accurately determine intrinsic protein solubility, because many proteins are highly soluble and thus large amounts of lyophilized protein are required to reach saturation in a given volume. For this reason, additives such as salts, long-chain polymers, or organic solvents often are used to precipitate proteins in order to determine solubility (Yoshikawa et al., Int. J. Biol. Macromol. 50:865-871, 2012; Schubert and Finn, Biotechnol. Bioeng. 23:2569-2590, 1981; and Hyde et al., Org. Process Res. Dev. 21:1355-1370, 2017). Controlling protein solubility is at the very core of the biotechnology industry, since protein precipitation is an important first step in almost all protein purification protocols.

The ability of a salt to precipitate a protein can be predicted by the Hofmeister series in which kosmotropic salts stabilize protein structure and induce salting out, while chaotropic salts destabilize and promote salting in (Hyde et al., supra). Ammonium sulfate ((NH₄⁺)₂SO₄²⁻) is strongly kosmotropic and has one of the highest solubilities in water (4.1 Mat 25° C.), making it one of the most effective salts for protein precipitation without causing denaturation. In solution, proteins are surrounded by a layer of water molecules known as the hydration layer. These water molecules interact with the protein surface through hydrogen bonding and electrostatic interactions, and are essential for maintaining protein structure, dynamics, and bioactivity (Zhang et al., Proc. Natl. Acad. Sci. USA 104:18461-18466, 2007). As the salt concentration is increased, the water molecules become attracted to the salt ions and are pulled away from the protein's surface. The hydration layer eventually is depleted, which promotes protein-protein hydrophobic interactions and after enough aggregation, precipitation of the proteins. The salting out point is different for each protein since each protein has a different surface charge composition and solubility. Ammonium sulfate precipitation is the principal technique in biotechnology used for both purification of a protein of interest from a crude mixture and for concentrating dilute solutions (Perosa et al., J. Immunol. Methods 128:9-16, 1990; Duong-Ly and Gabelli, “Salting out of proteins using ammonium sulfate precipitation,” in Laboratory Methods in Enzymology, vol. 541, pp. 85-94, 2014, Academic Press Inc.).

Since proteins precipitate at a certain salt concentration, most organisms cannot survive in high salinity due to cytoplasmic protein aggregation. However, halophiles have adapted to living in areas containing high salts, such as the Dead Sea or the Great Salt Lake (Lanyi, Bacteriol. Rev. 3 8:272-290, 1974; and Ortega et al., Chem. Biol. 22:1597-1607, 2015). There are two mechanisms for how halophiles are able to do this. First, halophiles accumulate osmolytes, such as betaines, in their cytoplasm that help control osmotic pressure while stabilizing proteins (Santos and da Costa, Environ. Microbiol. 4:501-509, 2002; and Nyyssola et al., J. Biol. Chem. 275:22196-22201, 2000). Second, halophiles have evolved to control cellular salt fluxes, and they have specially adapted intracellular proteins that withstand high salt concentrations (Lanyi, supra). Halophilic proteins have an abundance of negatively charged amino acids (aspartic acid and glutamic acid), short polar side chains, increased hydrophilicity, lower helical formation, and higher coil formation (Ortega et al., supra; and Paul et al., Genome Biol. 9:R70, 2008). Halophiles also have been categorized depending on the NaCl concentration in which they survive, where slight halophiles thrive in 0.34-0.85 M salt, moderate halophiles in 0.85-3.4 M salt, and extreme halophiles in 3.4-5.1 M salt (Ollivier et al., Microbiol. Rev. 58:27-38, 1994).

The intracellular betaine osmolytes used by some halophiles mimic the structure of zwitterionic polymer side chains originating from monomers such as 3-[[2-(methacryloyloxy) ethyl]dimethylammonio]propionate. The behavior of zwitterionic polymers in salt solutions has been examined for applications in antifouling, antibacterial surfaces, surface wetting, and anti-icing (Chen et al., Acta Biomater. 40:62-69, 2016; Xiao et al., Curr. Opin. Chem. Eng. 19:86-93, 2018; and Yang et al., Langmuir 31:9125-9133, 2015).

The studies discussed in the Examples herein were conducted to modify the surface of proteins with rationally designed polymers to evaluate the ability to tune protein solubility at high salt concentrations. As described herein, protein-initiated grafted-from ATRP was used to create large families of protein-polymer conjugates with particular salting out behaviors. The studies included varying the number of polymer chains (grafting density), polymer length (degree of polymerization, DP), and polymer type on a model protein, lysozyme (Lyz). Protein-polymer conjugate salting out points were determined by ammonium sulfate precipitation. Changes in hydrodynamic diameters and stabilities also were determined over time in increasing ammonium sulfate concentrations using dynamic light scattering. In addition, the enzymatic activities of the conjugates were measured in 4.1 M ammonium sulfate, and the difference in salting out points of native protein and protein-polymer conjugates was utilized to purify conjugates from a heterogeneous mixture.

Thus, this document provides conjugates containing a protein and one or more polymer chains, where the polymers confer increased or decreased solubility in saturated salt solution (e.g., a saturated solution of a kosmotropic salt, such as ammonium sulfate), relative to the solubility of the unconjugated protein in the saturated salt solution. This document also provides saturated salt solutions containing the conjugates described herein, as well as methods for engineering the solubility of proteins by conjugating the proteins to one or more polymers selected to confer increased or decreased solubility in saturated salt solution. In some cases, the proteins in the conjugates provided herein can retain at least partial function (e.g., at least 50%, at least 60%, at least 75%, or at least 90% of the function present without conjugation) when dissolved in the saturated salt solution.

Any appropriate protein can be used in the conjugates and methods provided herein. In some cases, for example, an enzyme (e.g., an esterase, lipase, organophosphate hydrolase, aminase, oxidoreductase, hydrogenase, lysozyme, transaminase, asparaginase, protease, or uricase) can be used in the conjugates and methods described herein. Other proteins that can be used in the methods and conjugates provided herein include, without limitation, avidin, antibodies, antigens, naturally occurring proteins, or genetically engineered proteins. In general, any protein can be used in the conjugates, solutions, and methods provided herein, provided that the protein has a functional group (e.g., a lysine or hydroxyl group, or any other appropriate group) on its surface for polymer conjugation.

As described herein, charged polymers, zwitterionic polymers, and polyelectrolyte polymers can confer increased solubility in saturated ammonium sulfate, while uncharged polymers can confer reduced solubility in saturated ammonium sulfate. The polymers can be homopolymers that contain a single type of monomer, or the polymers can be heteropolymers that contain two or more (e.g., two, three, or more than three) different monomers. Categories of polymer backbones that can be used in ATRP/RAFT procedures include, for example, styrenes, acrylates, acrylamides, methacrylates, methacrylamides, vinyl esters, vinyl amides. It is to be noted that the same side chain can be attached to different backbones to yield various polymers.

Non-limiting examples of charged polymers that can be included in the conjugates and used in the methods provided herein include negatively charged polymers [e.g., polymers with sidechains containing phosphate groups, sulfonate groups, and/or carboxylic acids, such as polysulfonate methacrylate (pSMA) and acrylamide), positively charged [e.g., polymers with sidechains containing ammonium groups and/or primary amines, such as dimethylaminoethyl acrylate (DMAEMA) at low pH, and polyquaternary ammonium (pQA)], and polymers containing a combination of positively and negatively charged monomers (e.g., random co-polymers of positively and negatively charged monomers). Suitable charged polymers also can include 2-(diethylamino) ethyl methacrylate (DEAEMA), N,N-dimethylacrylamide (DMA), and the examples mentioned above but with acrylate, acrylamide, methacrylate, or methacrylamide backbones.

Non-limiting examples of zwitterionic polymers that can be included in the conjugates and used in the methods provided herein include poly(carboxybetaine methacrylate) (pCBMA), poly(carboxybetaine acrylamide), poly(sulfobetaine methacrylate) (pSBMA), poly(sulfobetaine acrylamide), poly(2-methacryloyloxyethyl phosphorylcholine) (MPC, which contains phosphate and quaternary ammonium groups), poly[(3-(methacryloylamino)propyl)dimethyl(3-sulfopropyl)ammonium hydroxide] (MPDSAH, which contains quaternary ammonium and sulfonate groups), 1-(3-sulfopropyl)-2-vinylpyridinium betaine, and any of the examples mentioned above but with acrylate, acrylamide, methacrylate, or methacrylamide backbones. It is to be noted that zwitterionic polymers can have positive and negative charges on different monomers.

Non-limiting examples of polyelectrolyte polymers that can be included in the conjugates and used in the methods described herein include homo-polycations (e.g., polymers with positively charged sidechains as described above), homo-polyanions (e.g., polymers with negatively charged sidechains as described above), and hetero-polycations-polyanions.

Non-limiting examples of uncharged polymers that can be included in the conjugates and used in the methods provided herein include poly(oligo(ethylene glycol) methacrylate) (pOEGMA), polyethylene glycol (PEG), polydimethylamino ethyl methacrylate (pDMAEMA) at high pH (this polymer's charge is pH dependent), polyacrylamide, and polyvinyl pyrrolidone. Suitable uncharged polymers also can contain, without limitation, methyl acrylate, ethyl acrylate, butyl acrylate, hexyl acrylate, isobutyl acrylate, 2-ethylhexyl acrylate, isooctyl acrylate, 3, 5, 5-trimethylhexyl acrylate, 2-hydroxyethyl acrylate, 4-hydroxybutyl acrylate, N,N′-dimethylacrylamide, N-isopropylacrylamide, N-hydroxyethyl acrylamide, N-(isobutoxymethyl) acrylamide, methyl methacrylate, ethyl methacrylate, butyl methacrylate, hexyl methacrylate, isobutyl methacrylate, methacrylamide, N-isopropylmethacrylamide, vinyl propionate, (hydroxyethyl)methacrylate (HEMA), N-(2-hydroxypropyl)methacrylamide (HPMA), and combinations thereof.

The saturated salt solutions used in the methods provided herein can include ammonium sulfate or any other appropriate salt (e.g., any salt in the Hofmeister series that is classified as a kosmotrope, including salts of precipitating anions such as phosphate (PO₄³⁻) and precipitating cations such as ammonium (NH₄⁺). When ammonium sulfate is used, it can be present in solution at a concentration of about 3.5 to about 4.5 M (e.g., about 3.5 M, about 3.6 M, about 3.7 M, about 3.8 M, about 3.9

M, about 4.0 M, about 4.1 M, about 4.2 M, about 4.3 M. about 4.4 M. about 4.5 M, about 3.5 to about 3.7 M, about 3.6 to about 3.8 M, about 3.7 to about 3.9 M, about 3.8 to about 4.0 M, about 3.9 to about 4.1 M, about 4.0 to about 4.2 M, about 4.1 to about 4.3 M, about 4.2 to about 4.4 M, or about 4.3 to about 4.5 M). It is to be noted that the salt concentration needed to achieve saturation can depend on the temperature. For example, 100% saturation for ammonium sulfate is 4.1 M at 25° C., but about 3.8 Mat 0° C.

The protein-polymer conjugates provided herein can include polymers having any appropriate degree of polymerization (DP) (that is, each polymer can contain any appropriate number of monomer units and therefore have any appropriate length) and any appropriate grafting density (that is, any appropriate number of polymer chains can be coupled to the protein surface). In some cases, the polymers on a conjugate can have a DP between 2 and 500 (e.g., 2 to 10, 10 to 25, 25 to 50, 50 to 100, 100 to 200, 200 to 300, or 300 to 500). In some cases, a protein-polymer conjugate can have a grafting density of 1 to about 30 (e.g., 1, 2, 3, 4, 5, 6, 7, 8, 9, 10, 15, 20, 25, 30, 1 to 3, 3 to 5, 5 to 7, 7 to 10, 10 to 12, 12 to 15, 15 to 18, 18 to 20, 20 to 22, 22 to 25, 25 to 28, or 28 to 30) polymer chains per protein molecule, where the maximum grafting density is the number of reactive groups on the protein to which polymer chains can be attached (or on which polymer chains can be generated).

This document also provides saturated salt (e.g., ammonium sulfate) solutions with a protein-polymer conjugate dissolved therein. The conjugate can be present in the solution at a concentration of about 0.1 mg/mL to about to 100 mg/mL (e.g., about 0.1 to about 0.5 mg/mL, about 0.5 to about 1 mg/mL, about 1 to about 5 mg/mL, about 5 to about 10 mg/mL, about 10 to about 20 mg/mL, about 20 to about 50 mg/mL, about 50 to about 75 mg/mL, or about 75 to about 100 mg/mL).

In addition, this document provides methods for engineering the solubility of proteins. The methods can include providing a protein of interest, choosing one or more polymers that are likely to confer increased or decreased solubility in saturated ammonium sulfate, and generating one or more chains of the chosen polymer on the surface of the protein. As described herein, polymers selected to increase the solubility of the protein in saturated ammonium sulfate can be charged, zwitterionic, or polyelectrolyte polymers, while polymers selected to decrease the solubility of the protein in saturated ammonium sulfate can be uncharged polymers.

In addition, this document provides methods for generating protein-polymer conjugates. The methods can include selecting a polymer likely to confer high or low solubility to the protein in saturated ammonium sulfate, generating one or more chains of the selected polymer on the protein to yield the protein-polymer conjugate, and placing the protein-polymer conjugate in a saturated ammonium sulfate solution. Again, polymers selected to increase the solubility of the protein in saturated ammonium sulfate can be charged, zwitterionic, or polyelectrolyte polymers, while polymers selected to decrease the solubility of the protein in saturated ammonium sulfate can be uncharged polymers.

Any appropriate method can be used to generate polymers on a protein. In some cases, for example, atom transfer radical polymerization (ATRP) can be used. In some cases, reversible addition fragmentation chain-transfer (RAFT) polymerization can be used to generate polymer chains on a protein.

ATRP and RAFT are both types of controlled radical polymerization (CRP), in which the active polymer chain end is a free radical. ATRP is a type of a reversible-deactivation radical polymerization, and is a means of forming a carbon-carbon bond with a transition metal catalyst. ATRP typically employs an alkyl halide (R-X) initiator and a transition metal complex (e.g., a complex of Cu, Fe, Ru, Ni, or Os) as a catalyst. In an ATRP reaction, the dormant species is activated by the transition metal complex to generate radicals via electron transfer. Simultaneously, the transition metal is oxidized to a higher oxidation state. This reversible process rapidly establishes an equilibrium that predominately is shifted to the side with very low radical concentrations. The number of polymer chains is determined by the number of initiators, and each growing chain has the same probability of propagating with monomers to form living/dormant polymer chains (R-Pn-X). As a result, polymers with similar molecular weights and narrow molecular weight distribution can be prepared.

The basic ATRP process and a number of improvements are described elsewhere. See, for example, U.S. Pat. Nos. 5,763,546; 5,807,937; 5,789,487; 5,945,491; 6,111,022; 6,121,371; 6,124,411; 6,162,882; 6,624,262; 6,407,187;

6,512,060; 6,538,091; 6,541,580; 6,624,262 ; 6,627,314; 6,759,491 ; 6,790,919; 6,887,962; 7,019,082; 7,049,373; 7,064,166; 7,125,938 ; 7,157,530; 7.332,550; 7,407,995; 7,572,874; 7,678,869; 7,795,355; 7,825,199; 7,893,173; 7,893,174; 8,252,880; 8,273,823; 8,349,410; 8,367,051; 8,404,788; 8,445,610; 8,816,001; 8.865,795; 8,871,831; 8,962,764; 9,243,274; 9,410,020; 9,447,042; 9,533,297; and 9,644,042; and Publication Nos. 2014/0183055; 2014/0275420; and 2015/0087795.

ATRP also is discussed in a number of publications and reviewed in several book chapters. See, e.g., Matyjaszewski and Zia, Chem Rev 101:2921-2990, 2001; Qiu et al., Prog Polym Sci 26:2083-2134, 2001; Wang and Matyjaszewski, J Am Chem Soc 117:5614-5615, 1995; Coessens et al., Prog Polym Sci 26:337-377, 2001; Braunecker and Matyjaszewski, Prog Polym Sci 32:93-146, 2007; Matyjaszewski, Macromol 45:4015-4039, 2012; Schroder et al., ACS Macro Letters 1:1037-1040, 2012; Matyjaszewski and Tsarevsky, J Am Chem Soc 136:6513-6533, 2014; and Kamigaito et al., Chem Rev 101:3689-3746, 2001. Indeed, ATRP can control polymer composition, topology, and position of functionalities within a copolymer (Coessens et al., supra; Advances in Polymer Science; Springer Berlin / Heidelberg: 2002, Vol. 159; Gao and Matyjaszewski, Prog. Polym. Sci. 34:317-350, 2009; Blencowe et al., Polymer 50:5-32, 2009; Matyjaszewski, Science 333:1104-1105, 2011; and Polymer Science: A Comprehensive Reference, Matyjaszewski and Martin, Eds., Elsevier: Amsterdam, 2012; pp 377-428). All of the above-mentioned patents, patent application publications, and non-patent references are incorporated herein by reference to provide background and definitions for the present disclosure.

Monomers and initiators having a variety of functional groups (e.g., allyl, amino, epoxy, hydroxy, and vinyl groups) can be used in ATRP. ATRP has been used to polymerize a wide range of commercially available monomers, including various styrenes, (meth)acrylates, (meth)acrylamides, N-vinylpyrrolidone, acrylonitrile, and vinyl acetate as well as vinyl chloride (Qiu and Matyjaszewski, Macromol. 30:5643-5648, 1997; Matyjaszewski et al, J. Am. Chem. Soc. 119:674-680, 1997; Teodorescu and Matyjaszewski, Macromol. 32:4826-4831, 1999; Debuigne et al., Macromol. 38:9488-9496, 2005; Lu et al., Polymer 48:2835-2842, 2007; Wever et al., Macromol. 45:4040-4045, 2012; and Fantin et al., J. Am. Chem. Soc. 138:7216-7219, 2016). In general, non-limiting examples of monomers that can be used in ATRP reactions include carboxybetaine methacrylate (CBMA), oligo(ethylene glycol) methacrylate (OEGMA), 2-dimethylaminoethyl methacrylate (DMAEMA), sulfobetaine methacrylate (SBMA), 2-(methylsulfinyl)ethyl acrylate (MSEA), oligo(ethylene oxide) methyl ether methacrylate (OEOMA), and (hydroxyethyl)methacrylate (HEMA).

ATRP can be used to add polymer chains to the surfaces of proteins. An initial step in a protein-ATRP reaction is the addition of initiator molecules to the protein surface. In some cases, ATRP initiators (1) contain an alkyl halide as the point of initiation, (2) are water soluble, and (3) contain a protein-reactive “handle.” Alkyl halide ATRP-initiators usually include NHS groups that react with protein primary amines, including the N-terminal and lysine residues. Targeting amino groups can be an effective way to achieve the highest polymer coating due to the high abundance of amino groups on protein surfaces. The initiation reaction can be somewhat controlled using carefully designed algorithms that can predict specific reaction rates and sites of the individual amino groups (Carmali et al., ACS Biomater Sci Eng 2017, 3(9):2086-2097).

Any appropriate ATRP initiator can be used in the methods provided herein.

Suitable initiators can be based on, for example, 2-bromopropanitrile (BPN), ethyl 2-bromoisobutyrate (BriB), ethyl 2-bromopropionate (EBrP), methyl 2-bromopropionate (MBrP), 1-phenyl ethylbromide (1-PEBr), tosyl chloride (TsC1), 1-cyano-1-methylethyldiethyldithiocarbamte (MANDC), 2-(N,N-diethyldithiocarbamyl)-isobutyric acid ethyl ester (EMADC), dimethyl 2,6-dibromoheptanedioate (DMDBHD), 2-chloro-2-methypropyl ester (CME), 2-chloropropanitrile (CPN), ethyl 2-chloroisobutyrate (CliB), ethyl 2-chloropropionate (EC1P), methyl 2-chloropropionate (MC1P), dimethyl 2,6-dichloroheptanedioate (DMDC1HD), or 1-phenyl ethylchloride (1-PEC1). These initiators have a single alkyl halide group from which to initiate polymer growth. The number of chains grown from a protein using “grafting from” ATRP with amino-reactive, single-headed initiators cannot exceed the number of accessible amine groups on the surface of the protein.

The amino group at the N-terminus of a protein typically has a pKa in the range of 7.8-8.0, while the pKa's of lysine side chains range from about 10.5 to 12.0, depending on their local environment (Murata et al., Nat. Commun. 2018, 9, 845). Therefore, at biologically relevant pH values (6-8), the accessible amino groups are positively charged. During ATRP reactions, these positive charges are lost upon initiator attachment, as most (if not all) initiators typically used in ATRP reactions are neutral (see, e.g., Le Droumaguet and Nicolas, Polym. Chem. 2010, 1(5):563; and Broyer et al., Chem. Commun. 2011, 47(8):2212). In some cases, therefore, an initiator can include a group with a positive charge (in addition to an amine-reactive group and one or more alkyl halide or other groups that can react with a monomer to initiate polymer addition to the protein). For example, neutral initiator molecules such as those listed above can be modified by reaction with N-(3-N′,N′-dimethylaminopropyl)-2-bromo-2-methylpropanamide in the presence of acetonitrile, resulting in a molecule with an amine-reactive group, an alkyl halide from which monomer addition can be initiated, and a positively charged quaternary ammonium group.

In ATRP, a protein-initiator complex can be contacted with a population of monomers and a transition metal catalyst that includes a metal ligand complex, resulting in assembly of the monomers into polymer chains on the surface of the protein. Any appropriate metal ligand complex can be used. The transition metal in the metal ligand complex can be, for example, copper, iron, cobalt, zinc, ruthenium, palladium, or silver. The ligand in the metal ligand complex can be, without limitation, an amine-based ligand (e.g., 2,2′-bipyridine (bpy), 4,4′-di(5-nonyl)-2,2′-bipyridine (dNbpy), N,N,N′,N′-tetramethylethylenediamine (TMEDA), N-propyl(2-pyridyl)methanimine (NPrPMI), 2,2′:6′,2″-terpyridine (tpy), 4,4′,4″-tris(5-nonyl)-2,2′:6′,2″-terpyridine (tNtpy), ,N″,N″-pentamethyldiethylenetriamine (PMDETA), N,N-bis(2-pyridylmethyl)octylamine (BPMOA), 1,1,4,7,10,10-hexamethyltriethylenetetramine (HMTETA), tris[2-(dimethylamino)ethyl]amine (Me₆TREN), tris[(2-pyridyl)methyl]amine (TPMA), 1,4,8,11-tetraaza-1,4,8,11-tetramethylcyclotetradecane (Me4CYCLAM), or N,N,N′,N′-tetrakis(2-pyridylmethyl)ethylenediamine (TPEN).

RAFT polymerization makes use of a chain transfer agent in the form of a thiocarbonylthio or similar compound to provide control over the generated molecular weight and polydispersity during a free-radical polymerization. Further details with regard to RAFT polymerization are described elsewhere (see, e.g., Perrier, Macromolecules 50(19):7433-7447, 2017, which is incorporated herein by reference in its entirety).

This document also provides methods for purifying protein-polymer conjugates. The methods can include adding a salt (e.g., ammonium sulfate) to a solution containing a protein-polymer conjugate as described herein, where the salt is added in an amount sufficient to achieve a saturated salt solution and produce a precipitate. When the protein-polymer conjugate is soluble in the saturated salt solution, it will remain in the supernatant. The precipitate can be removed from the supernatant, resulting in at least partial purification of the protein-polymer conjugate that is retained in the supernatant. When the protein-polymer conjugate is not soluble in the saturated salt solution, it will precipitate, thereby being at least partially purified.

In some cases, this document provides methods that can be used to purify a target protein from a cell lysate. The methods can include providing a genetically modified target protein that includes one or more non-natural amino acids (e.g., non-natural amino acids containing initiator groups for ATRP or RAFT, click groups, or SpyCatcher/SpyTag system components) and/or one or more specific reactive groups (e.g., primary amines of lysine residues, carboxylic acids of glutamic acid and aspartic acid residues, free cysteines, or reduced disulfide bonds). A polymer (e.g., a charged, zwitterionic, or polyelectrolyte polymer) can be coupled to or grown from the non-natural amino acid(s) and/or specific reactive group(s), followed by ammonium sulfate precipitation (e.g., in a saturated ammonium sulfate solution). The target protein can remain soluble while other cell lysate contents precipitate. In some cases, the non-natural amino acid(s) and/or specific reactive group(s) can include a reversible or cleavable group so that the polymer can be cleaved after purification in response to a particular trigger (e.g., pH, light, chemicals, or temperature), yielding the un-conjugated target protein.

The invention will be further described in the following examples, which do not limit the scope of the invention described in the claims.

### EXAMPLES

### Example 1

### Materials and Methods

Materials: Lysozyme (Lyz) from hen egg white, α-chymotrypsin (CT) from bovine pancreas, glycine, copper(II) chloride (Cu(II)Cl), sodium ascorbate (NaAsc), 1,1,4,7,10,10-hexamethyltriethylenetetramine (HMTETA), and poly(ethylene glycol) methyl ether methacrylate (OEGMAsoo) were purchased from Sigma-Aldrich (St. Louis, Mo.). 3[[2-(Methacryloyloxy)ethyl]dimethylammonio] propionate (CBMA) was purchased from TCI America. HMTETA was purified using a basic alumina column. Pierce silver stain kit was purchased from ThermoFisher. SDS-PAGE gels (4-15% Mini-PROTEAN TGX precast gels) were purchased from Bio-Rad. All other chemicals were used without further purification and were purchased from Sigma Aldrich unless otherwise stated. The positively charged ATRP initiator was prepared as described elsewhere (Baker et al. 2019, supra). Dialysis tubing for purification was purchased from Spectra/Por, Spectrum Laboratories Inc., CA.

Instrumentation: Ultraviolet-visible (UV-VIS) spectrophotometry (Lambda 45, PerkinElmer) was used to determine protein concentrations from bicinchoninic acid (BCA) assays. Number average (Mₙ), weight average (M_{w}), and dispersity (B) of polymers (cleaved and free) were determined by gel permeation chromatography (GPC) (Waters 2695 Series) with a data processor, three columns (Waters Ultrahydrogel Linier, 250 and 500), and a refractive index detector using a running buffer of Dulbecco's Phosphate Buffered Saline with 0.02 wt % sodium azide at a flowrate of 1.0 mL/min. Calibration was performed using Pullulan standards (Polymer Standards Service, Amherst, Mass.). Matrix-assisted laser desorption/ionization time-of-flight mass spectrometry (MALDI-ToF MS) data was acquired on a Perseptive Biosystems Voyager, Elite MALDI-ToF spectrometer located in the Center for Molecular Analysis at Carnegie Mellon University. Dynamic light scattering (DLS) hydrodynamic diameters were measured on a Malvern Zetasizer nano-ZS located in the Department of Chemistry at Carnegie Mellon University. Ammonium sulfate precipitation analysis and enzymatic activities were measured on a Synergy H1 Multi-Mode Plate Reader (BioTek Instruments, Winooski, Vt.).

ATRP Initiator modifications (1, 3, 5) on Lyz: To synthesize Lyz with an average of 1 initiator modification (Lyz(1+)), 100 mg (0.007 mmol Lyz, 0.049 mmol NH₂) of native Lyz was dissolved in 20 mL of 0.1 M sodium phosphate buffer, pH 8. 25 mg of positively charged ATRP initiator (0.049 mmol, 1 equivalent against the number of NH₂ groups) was dissolved in 100 μL of DMSO. The dissolved initiator was added to the Lyz solution and stirred at 4° C. for 2 hours. Lyz-initiator was then purified by dialysis (8 kDa MWCO) against deionized water at 4° C. and was subsequently lyophilized.

To synthesize Lyz with an average of 3 initiator modifications (Lyz(3+)), 150 mg (0.01 mmol Lyz, 0.073 mmol NH₂) of native Lyz was dissolved in 29 mL of 0.1 M sodium phosphate buffer, pH 8. 114 mg (0.221 mmol, 3 equivalents against the number of NH₂ groups) of positively charged initiator, dissolved in 1 mL DMSO, was added to the Lyz solution and stirred for 2 hours at 4° C. Initiator modified Lyz was purified by dialysis as described above and was subsequently lyophilized.

To synthesize Lyz with an average of 5 initiator modifications (Lyz(5+)), 500 mg (0.035 mmol Lyz, 0.245 mmol NH₂) of Lyz was dissolved in 100 mL of 0.1 M sodium phosphate buffer, pH 8.631 mg of positively charged initiator (1.22 mmol, 5 equivalents against the number of NH₂ groups) was dissolved in 1 mL DMSO and was then added to the Lyz solution. The reaction solution was stirred at 4° C. for 2 hours. Initiator modified Lyz was purified by dialysis as described above and was subsequently lyophilized.

MALDI-ToF: Initiator modified Lyz (1 mg/mL) or native Lyz (1 mg/mL) was mixed with MALDI matrix (10 mg sinapinic acid, 250 μL of 0.1% trifluoroacetic acid and 250 μL of 50% acetonitrile) in 1:1 ratio. 2μL of mixed sample was loaded onto a sterling silver MALDI target plate. MALDI-TOF MS measurements were recorded using a Perseptive Voyager STR MS with a nitrogen laser (337 nm) and 20 kV accelerating voltage with a grid voltage of 90%. A total of 500 laser shots covering the complete spot were accumulated for each spectrum. Cytochrome C, apomyoglobin, and aldolase were used as calibration samples. The average number of initiator attached to Lyz was determined by taking the difference in peak m/z vales between native Lyz and Lyz-initiators and dividing by the mass of the reacted initiator (without NHS group) (321 Da).

ATRP from Lyz-initiator: 20 mg of Lyz(1+) (1.4 μmol ATRP initiator groups) and 7.8 mg CBMA for target DP of 25, 62 mg CBMA for target DP of 200, 17 mg OEGMA for target DP of 25, and 136 mg OEGMA for target DP of 200 were dissolved in 1120 μL of 0.1 M sodium phosphate, pH 8. Lyz(1+) and monomer solutions were bubbled under argon for about 7 minutes. Concurrently, 336 μL of 50 mM Cu(II)Cl in deionized water was bubbled under argon in a separate flask for 2 minutes. Next, 16.8 μL of 100 mM sodium ascorbate was added to the Cu(II)Cl solution. After that, 5.3 μL of HMTETA was added to reduced Cu(II) to Cu(I), and the solution was bubbled for an additional minute. Next, 280 μL of the Cu/ligand solution was added to the Lyz-initiator/monomer solution using a syringe and the sealed solution was stirred for 1 hour. The reaction was stopped by exposure to air and then the conjugates were purified using dialysis (8 kDa MWCO) against deionized water for 24 hours, followed by lyophilization.

30 mg of Lyz(3+) (6.4 μmol initiator groups) was dissolved in 5760 μL of 0.1 M sodium phosphate, pH 8. 37 mg CBMA or 81 mg OEGMA (target DP 25) and 295 mg CBMA or 644 mg OEGMA (target DP 200) were added to Lyz(3+) and bubbled for 15 minutes under argon. In a separate flask, 768 μL of 100 mM Cu(II)Cl solution was bubbled under argon for 2 minutes. Next, 77 μL of 100 mM sodium ascorbate solution was added to the bubbling Cu(II)Cl solution. Then, 25 μL HMTETA ligand was added to reduced Cu(II) to Cu(I), and the solution was bubbled for an additional minute. Next, 640 μL of the Cu/ligand solution was transferred via syringe to the Lyz-initiator/monomer solution. The polymerization was stopped by exposure to air after 1 hour of stirring. The conjugates were purified using dialysis (8 kDa MWCO) against deionized water for 24 hours, and were subsequently lyophilized.

30 mg (9.5 μmol initiator groups) of Lyz(5+) was dissolved in 18 mL of 0.1 M sodium phosphate, pH 8. 54 mg, 109 mg, 217 mg, 326 mg, and 434 mg CBMA (for target DPs of 25, 50, 100, 150 and 200, respectively) were added to Lyz(5+) and were bubbled under argon for 45 minutes. In a separate flask, 2.4 mL of 50 mM Cu(II)Cl solution was bubbled for 10 minutes. Next, 114 μL of 100 mM sodium ascorbate was added to reduce Cu(II) to Cu(I), and then 37 μL of HMTETA ligand was added. After that, 2 mL of the Cu/ligand solution was added to Lyz-initiator/CBMA solution. The reaction was stopped upon exposure to air after 1 hour for stirring. The Lyz(5+)pCBMA conjugates were purified using dialysis (8 kDa MWCO) against deionized water for 24 hour, and were subsequently lyophilized.

32 mg (10 μmol initiator groups) of Lyz(5+) and 126 mg, 252 mg, 505 mg, 758 mg and 1010 mg OEGMA (for the target DP of 25, 50, 100, 150 and 200, respectively) were dissolved in 9 mL of 0.1 M sodium phosphate, pH 8. The Lyz(5+)/monomer solution was bubbled for 30 minutes under argon. In a separate flask, 1.2 mL of 100 mM Cu(II)Cl solution was bubbled for 10 minutes. Next, 120 μL of 100 mM sodium ascorbate was added to reduce Cu(II) to Cu(I), and then 39 μL of HMTETA ligand was added. Then, 1 mL of the Cu/ligand solution was added to the Lyz(5+)/OEGMA solution. The reaction was stopped upon exposure to air after 1 hour or stirring, and the Lyz(5+)pOEGMA conjugates were purified using dialysis (8 kDa MWCO) against deionized water for 24 hours, followed by lyophilization.

Free polymer synthesis: 4.7 mg (0.92 mM final concentration) of neutral initiator (synthesized as described elsewhere; Murata et al., Biomacromolecules 14:1919-1926, 2013) and 442 mg CBMA (target DP 100) or 894 μL OEGMA (target DP 100) were dissolved in 20 mL of deionized water and bubbled under argon for 30 minutes. In a separate flask, 78 mg of Cu(II)Cl in 3 mL of deionized water was bubbled under argon. Next, 573 μL of a 20 mg/mL sodium ascorbate solution was added to reduce Cu(II) to Cu(I), and the solution was bubbled for 5 minutes before adding 186 μL of HMTETA, followed by additional bubbling for 1 minute. Next, 1 mL of the Cu/ligand solution was transferred to the initiator/monomer solution via syringe and the sealed flask was stirred for 1 hour at 25° C. The final concentrations in the ATRP reaction were 92 mM monomer, 0.92 mM initiator, 9.2 mM Cu(II) (reduced), 11 mM HMTETA, and 0.92 mM NaAsc. The polymerization was stopped by exposure to air and the polymers were purified by dialysis (1 kDa MWCO) against deionized water for 24 hours at 25° C. Purified polymers were lyophilized and analyzed by GPC for molecular masses and dispersities.

BCA assay to determine protein concentration: To determine the protein content in the conjugates, 1-3 mg/mL of Lyz-polymer samples were prepared in deionized water. 25 μL of the sample were then mixed with 1 mL of BCA solution (50:1 vol:vol of BCA and Cu(II)SO4) and incubated at 60° C. for 15 minutes. The absorbance was recorded at 562 nm. Protein concentration was determined against a standard curve of native Lyz (0.8-0.012 mg/mL) in deionized water. Lyz-polymer conjugates molecular masses and degree of polymerizations were estimated as described elsewhere (Murata et al. 2013, supra).

Dynamic light scattering to determine conjugate size in PBS: Hydrodynamic diameters of Lyz samples were determined on a Malvern Zetasizer nano-ZS. Lyz samples (native, initiator modified, and polymer modified) were dissolved at 1 mg/mL in 0.1 M sodium phosphate buffer, pH 8. Samples were filtered using a 0.45 μM cellulose acetate syringe filter and measured three times (15 runs per measurement). Reported values are number distribution hydrodynamic diameters.

Acid hydrolysis and GPC: 10-15 mg of Lyz-polymer conjugates were dissolved in hydrolysis tubes using 6N HC1 (5 mL). After three repetitions of freeze-pump-thaw cycles, the samples were place in an oil bath at 110° C. under vacuum for 20 hour. Cleaved polymers were purified by dialysis (1 kDa MWCO) against deionized water and were then lyophilized. Cleaved polymers were analyzed by GPC for molecular masses and dispersities using Pullulan standards as described in the Instrumentation paragraph above.

Ammonium sulfate precipitation: Native protein, protein-initiators, and protein-polymers were dissolved at 2 mg/mL protein concentration (starting volume was 1 mL) in 50 mM NaPhos buffer, pH 7. The initial concentrations of protein in the samples were measured by the absorbance 280 nm using a Synergy H1 plate reader. Absorbance values were converted to concentrations based on a standard curve of native protein (0 to 2 mg/mL). Solid amounts of ammonium sulfate were added to the solutions to reach the desired percent saturation as calculated from EnCor Biotechnology's online calculator at 25° C. (available online at encorbio.com/protocols/AM-SO4.htm). After each ammonium sulfate addition, samples were vortexed to ensure full dissolution of the ammonium sulfate. The samples were then allowed to sit on the benchtop for 15 minutes, followed by centrifugation at 16, 800×g for 20 minutes to pellet any precipitated protein. The protein concentration in the supernatant was measured in triplicate by absorbance at 280 nm. The supernatant used to determine protein concentration was placed back into the sample and the next solid mass of ammonium sulfate was added. The process of mixing, sitting, centrifuging, and measuring protein concentration was repeated after each ammonium sulfate addition until 100% saturation (4.1 M) was reached. The addition of ammonium sulfate increased the solution volume to 1.42 mL at 100% saturation.

Ammonium sulfate precipitation also was performed for native protein in the presence of free pCBMA or pOEGMA. In this case, native Lyz was dissolved at 2 mg/mL (1 mL starting volume) in 50 mM NaPhos buffer, pH 7. Lyophilized pCBMA or pOEGMA was added to match the amount (by mass), as estimated from the BCA results, of polymer present during the precipitation experiment of Lyz(5+)pCBMA DP 91 and Lyz(5+)pOEGMA DP 164. The process of ammonium sulfate precipitation was then carried out as described above.

Dynamic light scattering for size in ammonium sulfate: Native protein, protein-initiators, and protein-polymers were dissolved at 1 mg/mL protein concentration (starting volume 1 mL) in 50 mM NaPhos buffer, pH 7. Solutions were filtered using a 0.45 μM cellulose acetate syringe filter. The process used for ammonium sulfate precipitation (described above) was repeated, but instead of measuring protein concentration in the supernatant, hydrodynamic diameters were measured in triplicate (15 runs per measurement). Hydrodynamic diameters were measured at increasing ammonium sulfate concentrations until 100% saturation was reached. The changes in solution refractive index (Urrejola et al., J. Chem. Eng. Data 55:2924-2929, 2010), dielectric constant (Gavish and Promislow, Physical Review E, 94:012611, 2016), and viscosity (Nikam et al., J. Chem. Eng. Data 53:2469-2472, 2008) with increasing salt did not affect the hydrodynamic diameter output.

Dynamic light scattering to measure size stability: Lyz(5+)pCBMA DP 14 and DP 91 were dissolved at 1 mg/mL in 50 mM NaPhos buffer, pH 7. 0.77 mg of solid ammonium sulfate was added and dissolved to reach 100% saturation. Samples were filtered using a 0.45 μM cellulose acetate syringe filter. Immediately after filtering, hydrodynamic diameters were measured over 6 hours, and then again after 1 week, 2 weeks, and 2.5 months. Number and volume distributions were recorded from 15 scans per measurement.

Dynamic light scattering to measure size reversibility: Lyz(5+)pCBMA DP 91 was dissolved in 100% saturated ammonium sulfate at 1 mg/mL and the hydrodynamic diameter was measured. The sample was then diluted to 50% saturation (0.5 mg/mL) and 25% saturation (0.25 mg/mL) and hydrodynamic diameters were measured after each dilution as described above. Size reversibility also was tested by cycling between 50% and 100% saturation. Lyz(5+)pCBMA DP 91 was dissolved in 50% saturated ammonium sulfate at 1 mg/mL. The hydrodynamic diameter was measured and then solid ammonium sulfate was added to reach 100% saturation, followed by another hydrodynamic diameter measurement. The solution was diluted to 50% saturation again (0.5 mg/mL), measured by DLS, and then ammonium sulfate was added to reach 100% saturation again. This process was repeated one more time for a total of 3 complete cycles. Hydrodynamic diameters were measured as described above.

Enzymatic Activity Assay: Enzymatic activities of native Lyz, Lyz-initiators, and Lyz-pCBMA conjugates were measured using 4-methylumbelliferyl β-D-N,N′, N″-triacetylchitotrioside, a small molecule fluorescent substrate (λₑₓ=360 nm, λₑₘ=455 nm). Lyz solutions were prepared at 1 mg/mL (Lyz concentration) in 50 mM NaPhos, pH 6.0. The substrate was dissolved in DMSO at 5 mg/mL (6.4 mM). To start the reaction, 29 μL of the 1 mg/mL Lyz solution (2 μM final concentration) was added with 8μL of substrate solution (50 μM final concentration) and 963 mL of either 50 mM NaPhos (pH 6.0) or 100% saturated ammonium sulfate. Reactions were incubated at 37° C. in a water bath. At increasing time points over 4 hours, 50 μL of the reaction mixture was mixed with 150 μL of stop buffer (100 mM glycine-NaOH, pH 11) in a 96 well plate. The fluorescence intensities (relative fluorescence units: RFU) were then measured in triplicate. Reaction rates were corrected by blanks of the substrate (8 μL) in either NaPhos, pH 6.0 and 100% saturated ammonium sulfate (992 μL). RFU versus reaction time plots were fit to linear regressions in GraphPad.

Purification and SDS-PAGE gel analysis (pCBMA and pOEGMA): Native Lyz and Lyz(5+)pOEGMA, and Lyz(5+)pCBMA DP 91 were prepared at 1 mg/mL in deionized water. Native Lyz and conjugates were mixed at a 1:99 volume ratio (10 native Lyz and 990 μL conjugate). Solid ammonium sulfate was added to reach 100% saturation for pCBMA (0.77 g) or 40% saturation for pOEGMA (0.25 g). The mixtures were allowed to sit for 1 hour on the benchtop, followed by centrifugation at 16,800×g for 1 hour. The supernatants were aspirated and the precipitates were re-dissolved in 1 mL of deionized water. Supernatants and precipitates were dialyzed in deionized water to remove ammonium sulfate for 24 hours at 4° C. Ultrafiltration (3 kDa MWCO) was performed on dialyzed samples to concentrate them back to starting concentrations. SDS-PAGE analysis was performed on native Lyz, Lyz(5+)pCBMA DP 91, Lyz(5+)pOEGMA DP 164, supernatants, precipitates, the starting mixture (prior to salt addition), and standards. 25 μL of samples were mixed with 25 μL of sample buffer (190 μL of 2X Lamaelli sample buffer with 10μ.L of 2-mercaptoethanol). Samples were heated at 95° C. for 10 minutes in an oil bath. Running buffer was composed of lx Tris/Glycine/SDS buffer. Samples (20 μL or 10 μL of ladder) were loaded into the wells of a 4-15% precast gel and electrophoresis was run at 100 V, 4 W, 40 mA for 40 min. Gels were then silver stained following the protocol provided by the Pierce Silver Stain kit.

Chymotrypsin polymer synthesis and characterization: Chymotrypsin (CT)-polymers that were synthesized and characterized as described elsewhere (Baker et al. 2018, supra) were used for ammonium sulfate precipitation analysis. Briefly, CT was modified with 12 neutral initiators and long chained polymers of zwitterionic poly(carboxybetaine methacrylate) (pCBMA), neutral poly(oligoethylene glycol methacrylate) (pOEGMA), neutral to positive poly(dimethylaminoethyl methacrylate) (pDMAEMA), positive poly(quarternary ammonium meth- acrylate) (pQA), or negative poly(sulfonate methacrylate) (pSMA), which were grown from the surface of CT-neutral initiator using ATRP. Conjugates were characterized with a BCA assay and dynamic light scattering. Acid hydrolysis was performed to cleave polymers followed by GPC analysis as described above.

Example 2

### Conjugate Synthesis and Characterization

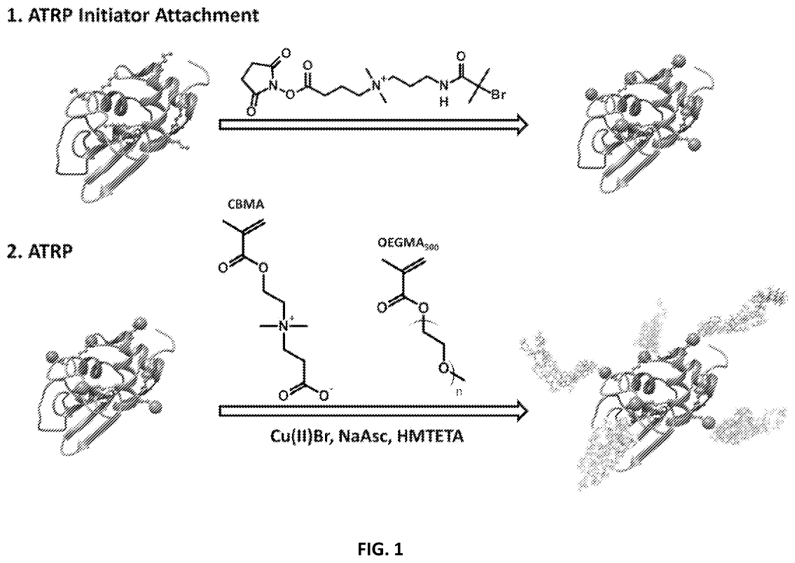

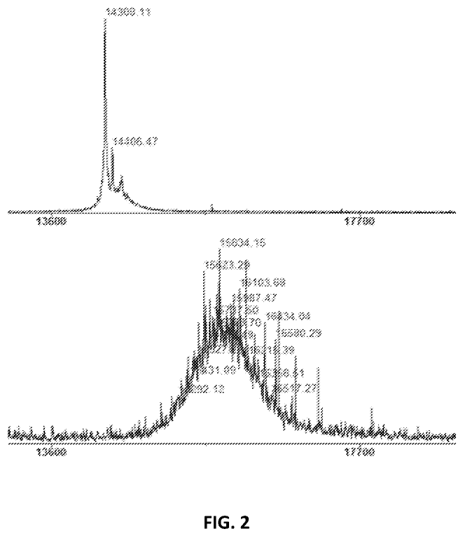

Lysozyme-polymer conjugates were synthesized with a high grafting density and varied polymer chain lengths using grafting-from ATRP (FIG. 1). Two polymers at five chain lengths each were chosen to study the effect of polymer attachment on solubility: zwitterionic poly(carboxybetaine methacrylate) (pCBMA) and neutral poly(oligo(ethylene glycol) methacrylate) (pOEGMA). These polymers also have significantly different octanol-water distribution coefficients (logD), as the logD of CBMA monomer is about −2.35 and the logD of OEGMA is about 0.84 (Baker et al. 2018, supra). Clearly, CBMA is more hydrophilic than OEGMA, and while both are net neutral, CBMA is highly charged. Small molecule positively charged ATRP initiators (Baker et al. 2019, supra) were first reacted with the available 7 amino groups on the Lyz surface. The number of reacted initiators was determined by the change in mass of Lyz-initiator compared to native Lyz analyzed by matrix-assisted laser desorption/ionization time of flight (MALDI-ToF) mass spectroscopy (FIG. 2). The average of 5 attached initiators (5+) were the sources for polymer growth via ATRP. Polymer chain length was increased by increasing the monomer to initiator ratio in the ATRP reaction (targeted DPs from 25 to 200). Lyz-polymer conjugates were purified via dialysis and then lyophilized.

A bicinchoninic acid (BCA) protein assay was used to determine protein concentration in the conjugate samples from which polymer concentration, molecular mass, and degree of polymerization were estimated (Murata et al. 2013, supra). Targeted DPs during ATRP were 25, 50, 100, 150, and 200, yielding measured DPs of 18, 32, 56, 79, and 91 for pCBMA conjugates and 25, 43, 90, 105, 164 for pOEGMA conjugates, respectively (TABLE 1).

TABLE 1
Lyz-polymer characterization*

| | Estimated | | Cleaved polymer | |
|---|---|---|---|---|
| Sample* | DP* | Dₕ (nm) | Mₙ (kDa) | Ð |
| Lyz | — | 3.6 ± 0.1 | — | — |
| Lyz(5+)pCBMA₂₅ | 18 | 7.9 ± 0.4 | 8.1 | 1.4 |
| Lyz(5+)pCBMA₅₀ | 32 | 11.0 ± 1.0 | 11.9 | 1.6 |
| Lyz(5+)pCBMA₁₀₀ | 56 | 13.4 ± 0.9 | 20.9 | 1.7 |
| Lyz(5+)pCBMA₁₅₀ | 79 | 15.4 ± 0.8 | 30.8 | 1.8 |
| Lyz(5+)pCBMA₂₀₀ | 91 | 16.8 ± 0.8 | 38.7 | 1.9 |
| Lyz(5±)pOEGMA₂₅ | 25 | 9.2 ± 0.8 | 17.5 | 1.7 |
| Lyz(5±)pOEGMA₅₀ | 43 | 12.6 ± 1.1 | 26.9 | 1.8 |
| Lyz(5±)pOEGMA₁₀₀ | 90 | 20.2 ± 1.7 | 46.6 | 1.9 |
| Lyz(5+)pOEGMA₁₅₀ | 105 | 22.2 ± 2.9 | 53.2 | 1.8 |
| Lyz(5+)pOEGMA₂₀₀ | 164 | 26.2 ± 3.0 | 85.4 | 1.7 |

*Data were collected using a bicinchoninic acid (BCA) assay to estimate degree of polymerization (DP), dynamic light scattering number distribution to measure hydrodynamic diameter (Dh), and acid hydrolysis with gel permeation chromatography (GPC) to calculate number-average molecular mass (Mn) and dispersity (Ð) of cleaved polymer. DLS data are presented as mean number distributions ± 1 standard deviation error bars.
*Subscript numbers represent the targeted DP from the ATRP reaction. Estimated DPs are calculated from the BCA assay (Murata et al. 2013, supra). The (5+) represents the number of positively charged initiators on the conjugate.

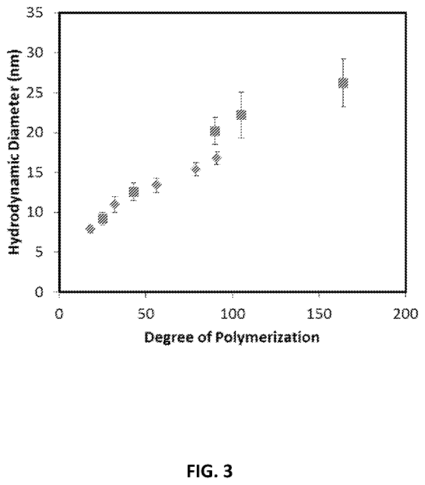

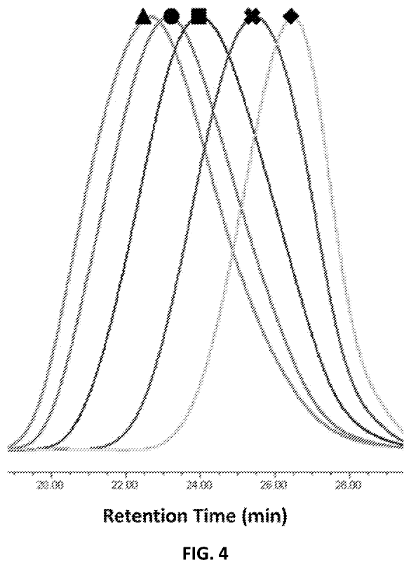

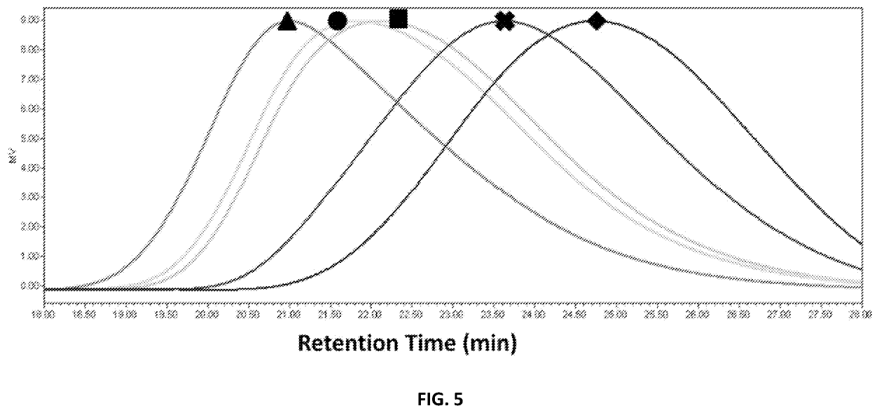

Conjugates were next characterized by dynamic light scattering (mean number distribution ±1 standard deviation error bar) in phosphate buffered saline (PBS) to determine how an increase in chain length correlated with increased conjugate size (FIG. 3). Native Lyz had a hydrodynamic diameter of 3.6±0.1 nm, Lyz-pCBMA conjugates increased in hydrodynamic diameters from 7.9±0.4 nm (DP 18) to 16.8±0.8 nm (DP 91), and Lyz-pOEGMA conjugates increased in hydrodynamic diameters from 9.2 ±0.8 nm (DP 25) to 26.2 ±3.0 nm (DP 164) (TABLE 1). Additionally, polymers were cleaved from Lyz by acid hydrolysis and were analyzed by gel permeation chromatography (GPC) for molecular mass (Mn) and dispersity (1)). Polymer Mn increased from 8.1 kDa (1) 1.4) to 38.7 kDa (1) 1.9) for pCBMA and from 17.5 kDa (1) 1.7) to 85.4 kDa (1) 1.7) for pOEGMA (TABLE 1 and FIGS. 4 and 5).

### Example 3

### Effect of Polymer Length on Conjugate Solubility

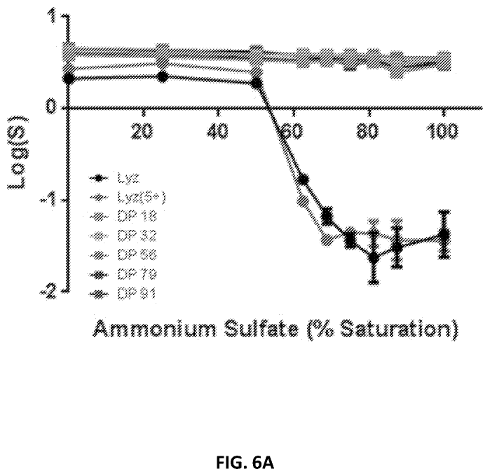

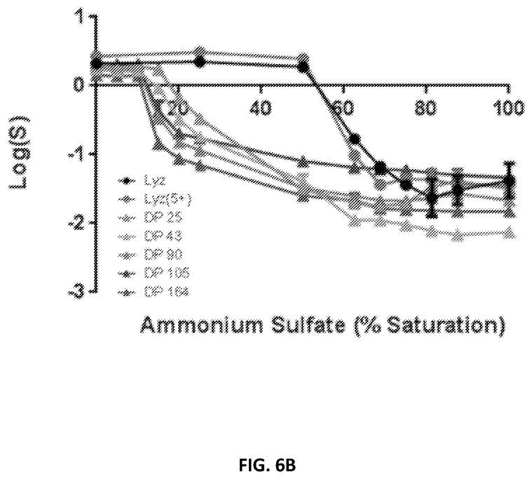

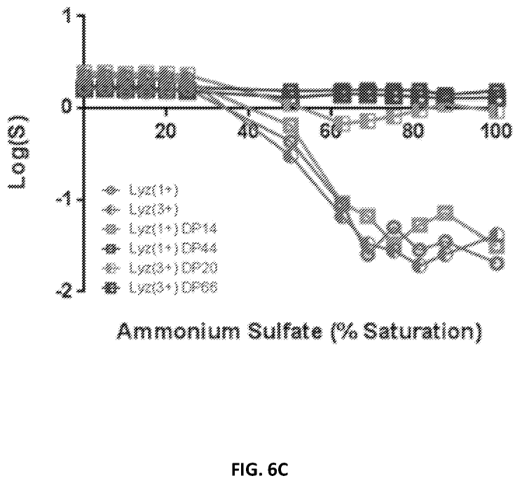

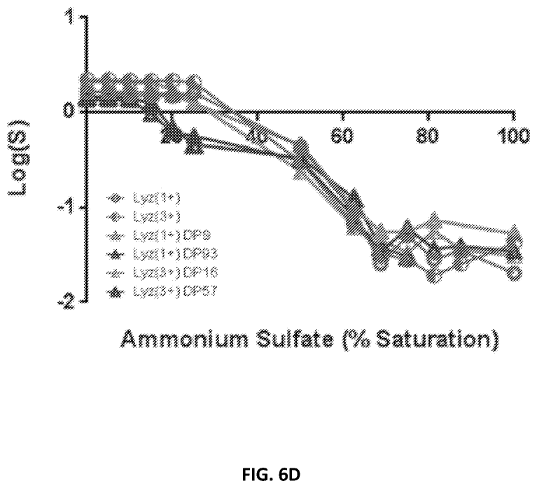

Native Lyz, Lyz-initiator, and Lyz-polymer conjugates were subjected to precipitation by ammonium sulfate at pH 7.0 to determine their salting out points (FIGS. 6A and 6B). Lyz has been shown to salt out as predicted by the anion Hofmeister series at basic pH values and high ionic strength, but salt out according to the reversed anion Hofmeister series at neutral to acidic pH and moderate ionic strength (Zhang et al., Proc. Natl. Acad. Sci. USA 106:15249-15253, 2009; and Bostrom et al., Langmuir 27:9504-9511, 2011). Additionally, Lyz solubility can be predicted from the cation Hofmeister series when pH <pI (Lyz pI: —11) (Watanabe et al., Fluid Phase Equilib. 281:32-39, 2009). Native Lyz, as expected (Kramer et al., supra), precipitated around 60% saturated ammonium sulfate (2.5 M) (FIGS. 6A and 6B). Lyz-initiator also precipitated around 60% saturation. A charge-preserving ATRP initiator (Baker et al. 2019, supra) was used to synthesize the Lyz-conjugates so that the positive charges on amino groups were retained after initiator attachment. Therefore, the net numbers of positive and negative charges on the protein surface were preserved after initiator attachment causing Lyz-initiator to salt out at a similar salt concentration to native Lyz.

Since free zwitterionic polymers are highly solvated in water and solvation increases with salt concentration (Shao et al., J. Phys. Chem. B 115:8358-8363, 2011; and Wang et al., Polym. Int. 64:999-1005, 2015), it would follow that increasing pCBMA length would increase conjugate hydrophilicity and therefore increase the salt concentration needed to salt out Lyz-pCBMA conjugates. Lyz(5+)pCBMA conjugates actually exhibited no salting out behavior, independent of DP, even up to 100% saturation (4.1 M) (FIG. 6A). Very few native proteins are soluble in 100% ammonium sulfate, and most precipitate in the range of 40-60% saturation. Saturated ammonium sulfate is, after all, about 7 times the ionic strength of seawater. Conversely, Lyz(5+)pOEGMA conjugates exhibited a length-dependent reduction in salting out concentration (FIG. 6B). Although the net surface charge on Lyz-pOEGMA was similar to that of native Lyz, the dense molecular shell of uncharged, amphiphilic polymers undoubtedly increased the hydrophobicity of the entire complex. Increasing the pOEGMA chain length decreased the conjugate's solubility. Long-chained Lyz(5+)pOEGMA with a DP of 164 precipitated around 10% saturation and the salting out point increased according to DP, while short-chained DP 25 Lyz(5+)pOEGMA didn't precipitate until about 20% saturation. It can be surmised that conjugate hydrophobicity increased with pOEGMA length (Muller et al., J. Chromatogr. A 1217:4696-4703, 2010).

Further studies were conducted to determine whether the observed differences in solubility were due to covalent polymer conjugation versus the presence of polymer in solution, since proteins have been precipitated non-covalently by some PEGs (Juckles, Biochim. Biophys. Acta-Protein Struct. 229:535-546, 1971; and Polson et al., Biochim. Biophys. Acta-Gen. Subj. 82:463-475, 1964). A more recent study found that unattached (free) charged polymers with a size 25 times larger than the protein's diameter could induce protein precipitation by wrapping themselves around the protein to neutralize surface charges (Capito et al., J. Polym. Res. 21:346, 2014).

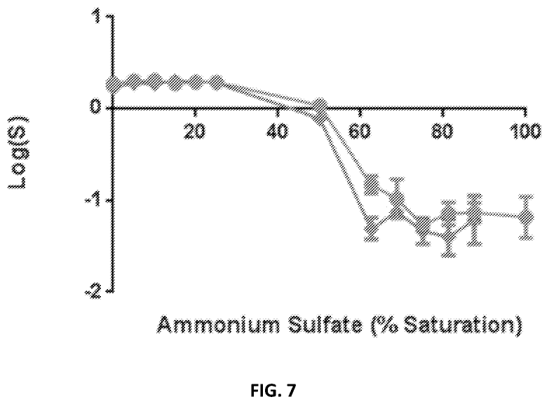

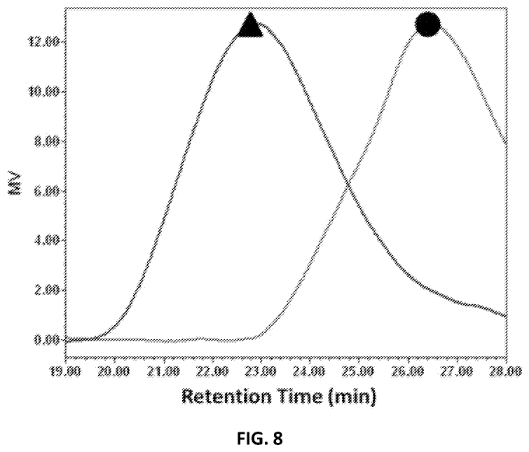

Thus, free pCBMA and pOEGMA were synthesized, ammonium sulfate precipitation of native Lyz in the presence of the free polymers was performed (FIGS. 7 and 8). The concentrations of free polymers used matched the mass concentrations of polymers in the long-chained Lyz(5+)pCBMA (DP 91) and Lyz(5+)pOEGMA (DP 164) ammonium sulfate precipitation samples. The presence of free polymers did not affect Lyz solubility and Lyz precipitated around 60% saturation in the presence of both pCBMA and pOEGMA (FIG. 7), showing that covalent attachment of the polymer to the protein was required in order to tune the solubility of the conjugates in salt solutions.

### Example 4

### Effect of Grafting Density on Conjugate Solubility

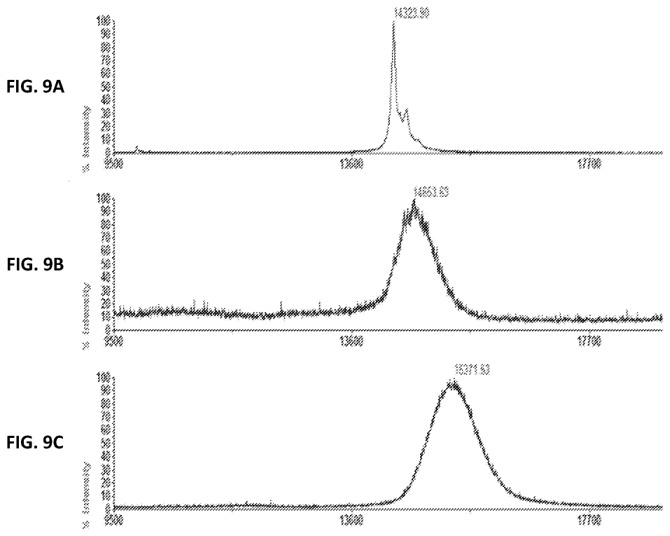

Since all of the Lyz(5+)pCBMA conjugates remained soluble up to 100% saturation and Lyz(5+)pOEGMA conjugates precipitated at relatively low percent saturations, studies were conducted to investigate whether there was a minimum amount of polymer that would elicit a change in the salting out point from native Lyz. Lyz-pCBMA and Lyz-pOEGMA conjugates were synthesized with lower grafting densities—specifically, 1 and 3 average initiator modifications (FIG. 9). From each Lyz-initiator, short and long chained pCBMA and pOEGMA were grown. Conjugates were characterized using a BCA assay to estimate DP (Murata et al. 2013, supra) and DLS to determine hydrodynamic diameter (TABLE 2). Lyz with 1 initiator had pCBMAs of DP 14 (5.2±0.8 nm) or DP 44 (6.0±0.8 nm) and pOEGMAs of DP 9 (5.9±0.8 nm) or DP 93 (14.0±2.5 nm). Lyz with 3 initiators had pCBMAs of DP 20 (5.3±1.1 nm) or DP 66 (12.7±1.5 nm) and pOEGMAs of DP 16 (7.9±1.5 nm) or DP 57 (18.0±3.3 nm).

Ammonium sulfate precipitation of the variable grafting density conjugates (FIGS. 6C and 6D) showed that the conjugate with the least amount of polymer, Lyz(1+)pCBMA DP 14 did not remain soluble in saturated ammonium sulfate. For Lyz-pOEGMA, polymer length, rather than grafting density, influenced the salting out point. Long chain pOEGMA conjugates with 1 or 3 initiators precipitated first (around 20% saturation), while short chain pOEGMA conjugates precipitated similarly to Lyz-initiator (at around 60% saturation). The range of concentrations over which the pOEGMA conjugates precipitated could have been related to heterogeneity within the samples (not every conjugate molecule had the same number of polymer chains attached). Indeed, ammonium sulfate precipitation should be an excellent route to fractionating heterogeneous polymer-protein conjugate solutions.

TABLE 2
Lyz-polymer characterization for conjugates with
1 initiator (1+) or 3 initiators (3+).

| | Estimated | Dₕ (nm; number |
|---|---|---|
| | DP* | dist.) |
| Lyz(1+) | — | 3.3 ± 0.3 |
| Lyz(3+) | — | 3.7 ± 0.2 |
| Lyz(1+) pCBMA | 14 | 5.2 ± 0.8 |
| | 44 | 6.0 ± 0.8 |
| Lyz(1+) pOEGMA | 9 | 5.9 ± 0.8 |
| | 93 | 14.0 ± 2.5 |
| Lyz(3+) pCBMA | 20 | 5.3 ± 1.1 |
| | 66 | 12.7 ± 1.5 |
| Lyz(3+) pOEGMA | 16 | 7.9 ± 1.5 |
| | 57 | 18.0 ± 3.3 |

*DP was estimated from BCA results.

### Example 5

### Zwitterionic Conjugate Stability in Ammonium Sulfate

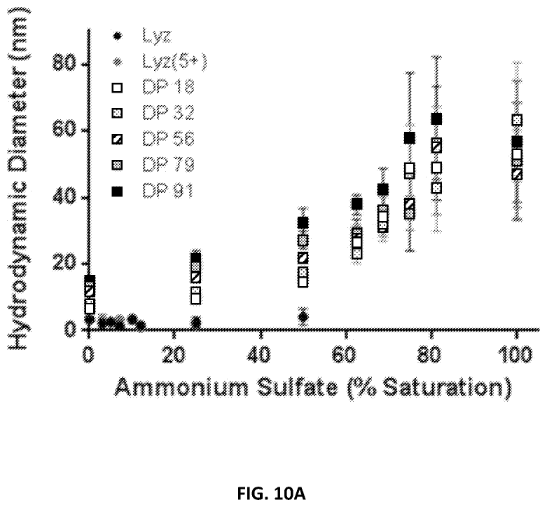

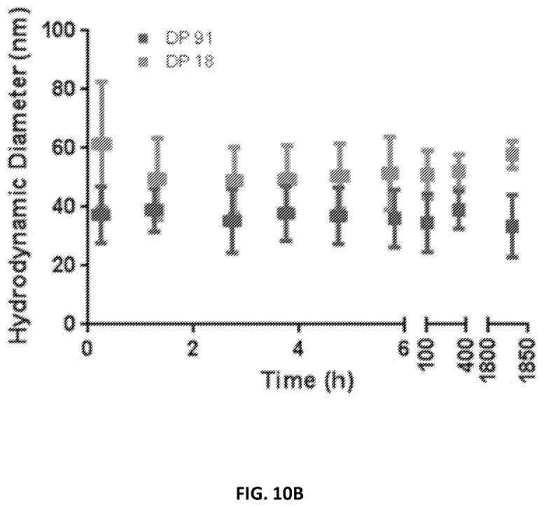

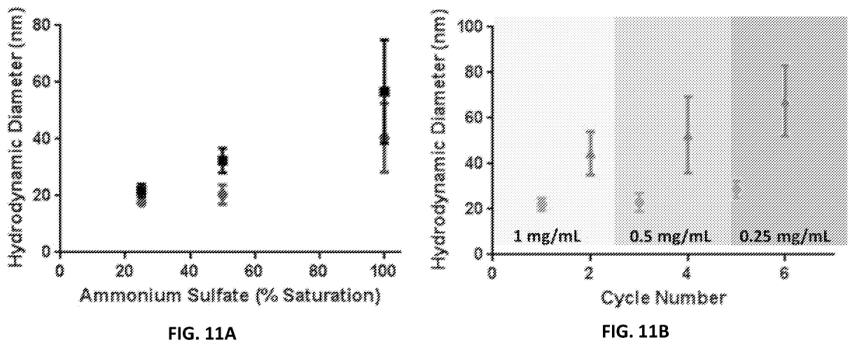

Since all Lyz(5+)pCBMA conjugates had solubilities up to 100% in saturated ammonium sulfate, studies were conducted to investigate how their hydrodynamic diameters changed with increasing salt concentration, and whether the size of the conjugates changed over time. Ammonium sulfate precipitation was performed again on Lyz(5+)pCBMA conjugates and DLS measurements of the supernatants were taken at each increasing ammonium sulfate concentration (FIG. 10A). The hydrodynamic diameters of native Lyz and Lyz-initiator were relatively stable up to 50% saturation. Beyond this point, the samples precipitated and DLS measurements of the supernatants were not able to be performed. Lyz(5+)pCBMA conjugates, however, displayed reversible (FIG. 11) increases in hydrodynamic diameters up to 100% saturation, where the hydrodynamic diameters of all conjugates were around 60 nm by number distribution. Additionally, the standard deviation in the measurements increased as salt concentration increased.

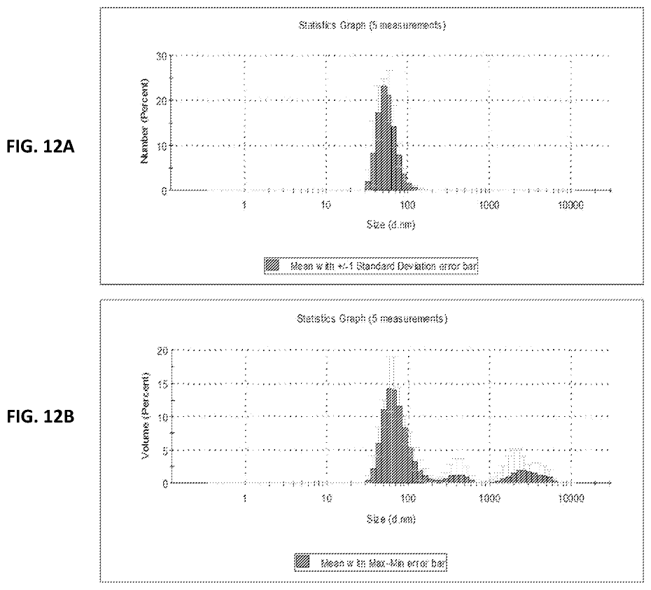

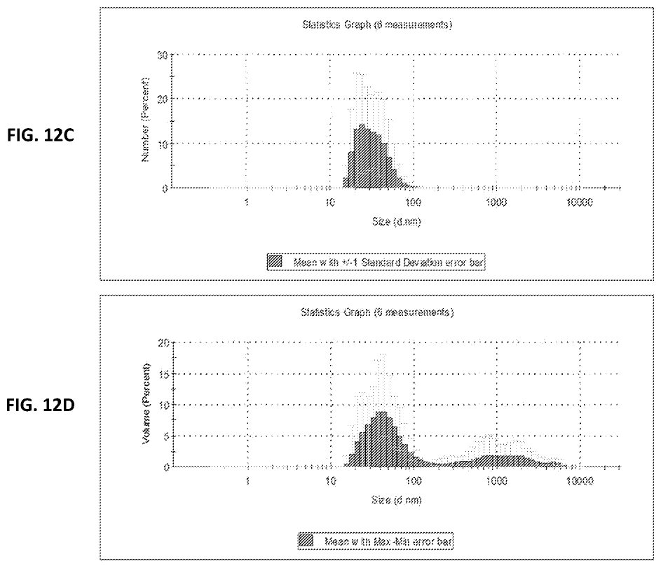

Next, the polymer length effect on the rate of change in conjugate IA during storage in saturated ammonium sulfate solution was determined (FIG. 10B). The hydrodynamic diameters of both the short DP 18 and long DP 91 conjugates were stable for up to 2.5 months. Storage of protein solutions, especially for pharmaceuticals, in ammonium sulfate is of great interest because it inhibits bacterial growth and prevents contamination during shelf storage (Wingfield, Curr. Protoc. Protein Sci. 3:1-10, 2001). The increases in pCBMA conjugate size with salt concentration could be attributed to either micro-aggregation or an actual change in conjugate size. Although single peaks were detected in number distributions up to 100% saturation, multimodal peaks became prominent in the volume distributions at 70% saturation (FIG. 12). At about this salt concentration, an increase in the standard deviations of the DLS measurements also was noted. This indicated a small degree of micro-aggregation, which did not result in precipitation, at ammonium sulfate concentrations above 70%. An actual change in conjugate size could have resulted from the anti-polyelectrolyte effect. The anti-polyelectrolyte effect of zwitterionic polymers has been studied in depth for non-fouling biomaterials, but has not been studied for the polymers bound to proteins (Yang et al., supra; Gao et al., Eur. Polym. J. 53:65-74, 2014; Georgiev et al., Biomacromolecules 7:1329-1334, 2006; and Shao et al., supra). Zwitterionic polymers are composed of an equal number of positive and negative charges. Intra- and inter-chain electrostatic interactions cause the polymer to adopt a more collapsed conformation in water. As salt concentration is increased, the salt ions neutralize the electrostatic interactions and allow the polymer chains to extend in solution and become more hydrated. Although the data reported herein would be the first direct observation of this effect in a protein-polymer conjugate, the anti-polyelectrolyte chain extension could have contributed to the observed increase in hydrodynamic diameter. Changes in polymer conformation caused by anti-polyelectrolyte effects would also increase intrinsic viscosity (Georgiev et al., supra; and Zhang et al., Biomacromolecules 9:2686-2692, 2008). DLS actually measures the diffusion coefficient of a particle in solution due to Brownian motion and converts this parameter to a hydrodynamic diameter using the Stokes-Einstein equation. Therefore, an increase in intrinsic viscosity would decrease the diffusion coefficient of a particle and increase hydrodynamic diameter (Lezov et al., Polym. Sci. Ser. A 53:1012-1018, 2011; and Wang et al., supra). Further studies were therefore conducted to determine whether zwitterionic polymer chains might extend as a function of salt concentration, and to investigate how such behavior would differ from pOEGMA-protein conjugates at the atomistic level.

### Example 6

### Conjugate Activity in 100% Saturated Ammonium Sulfate

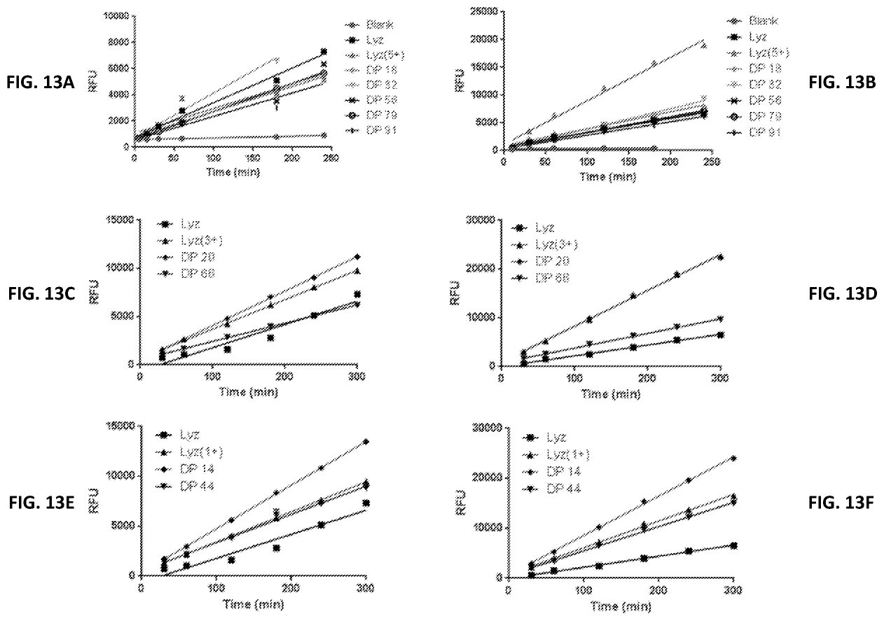

The newly discovered solubility of a protein in saturated salt solutions raises the interesting question of whether functional activity can be retained in this environment. A challenge in most precipitation methods is loss of protein function. Studies were therefore conducted to determine the activity of Lyz-pCBMA conjugates containing 1, 3, and 5 polymer chains in saturated ammonium sulfate using a small molecule fluorescent substrate, 4-methylumbelliferyl β-D-N,N,N″-triacetylchitotrioside. There was no correlation between activity and pCBMA length in either 50 mM sodium phosphate (NaPhos) or saturated ammonium sulfate (TABLE 3 and FIGS. 13A-13F). Lyz remained active after initiator attachment and pCBMA growth. Lyz(5+)pCBMA conjugates had increased activities in 100% saturated ammonium sulfate and were up to 1.6 times higher than the corresponding activities in NaPhos buffer, even at slightly lower pH (pH 6.0 versus pH 5.5). Interestingly, Lyz-initiator displayed the highest activity in ammonium sulfate (4.2 times more than in NaPhos buffer). Activities of Lyz-pCBMA conjugates with 1 and 3 initiators were also measured (TABLE 3 and FIG. 13A-13F). The conjugates remained active after polymer growth and were, again, more active in 100% ammonium sulfate. Additionally, Lyz(1+) and Lyz(3+) were 1.8 and 2.4 times more active in ammonium sulfate than NaPhos, respectively. Lyz-initiator should be aggregated at 100% ammonium sulfate saturation. Aggregation typically leads to unfolding and loss of activity. The ammonium cation is highly kosmotropic, however, and stabilizes the protein structure during precipitation to keep Lyz active. The chemical structure of the initiator contains a positively charged quaternary ammonium. This could have strongly attracted sulfate anions and slightly changed the arrangement of the active site residues to strengthen the active site-substrate interaction to increase activity in ammonium sulfate (Imoto et al., J. Biochem. 65:667-671, 1969).

TABLE 3
Enzymatic activities* of Lyz, Lyz-initiators, and Lyz-
pCBMA conjugates of increasing DP in 50 mMNaPhos buffer
and 100% saturated ammonium sulfate (4.1M).

| | | Reaction Rate (RFU min⁻¹) | | |
|---|---|---|---|---|
| | | 50 mM | 4.1 M Ammonium | Ratio |
| | | NaPhos | Sulfate | (Ammonium |
| | | (pH 6.0) | (pH 5.5) | Sulfate:NaPhos) |
| 5 | Lyz | 26.5 ± 1.5 | 25.6 ± 1.5 | 1.0 |
| initi- | Lyz(5+) | 18.8 ± 3.8 | 78.4 ± 4.3 | 4.2 |
| ators | DP 18 | 19.3 ± 1.3 | 30.7 ± 2.0 | 1.6 |
| | DP 32 | 33.9 ± 4.4 | 36.3 ± 1.6 | 1.1 |
| | DP 56 | 21.3 ± 2.6 | 26.6 ± 1.1 | 1.2 |
| | DP 79 | 21.3 ± 0.2 | 28.2 ± 0.9 | 1.3 |
| | DP 91 | 17.9 ± 2.2 | 24.2 ± 0.7 | 1.4 |
| 3 | Lyz(3+) | 30.6 ± 0.6 | 74.1 ± 1.5 | 2.4 |
| initi- | DP 20 | 35.8 ± 0.3 | 73.2 ± 2.3 | 2.0 |
| ators | DP 66 | 19.0 ± 0.1 | 30.1 ± 0.6 | 1.6 |
| 1 | Lyz(1+) | 30.1 ± 0.1 | 53.4 ± 1.3 | 1.8 |
| initi- | DP 14 | 43.7 ± 0.3 | 78.6 ± 1.4 | 1.8 |
| ator | DP 44 | 28.3 ± 1.2 | 48.5 ± 0.8 | 1.7 |

*Activity was measured using the fluorescent substrate 4-Methylumbelliferyl β-D-N,N′,N″-triacetylchitotrioside over 4 hours. Data were fit to linear regressions to obtain the reaction rate. Error represents the standard deviations from triplicate measurements.

### Example 7

### Purification by Utilizing Different Salting Out Points

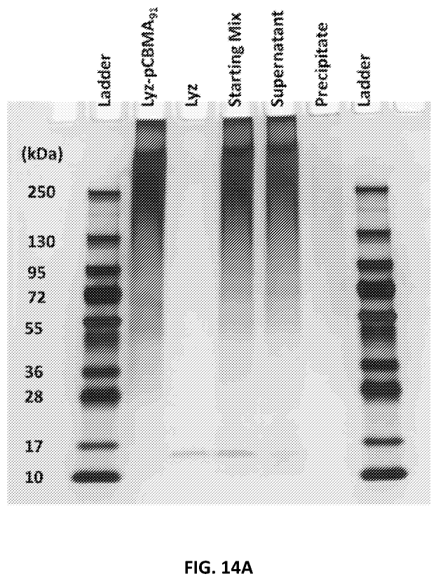

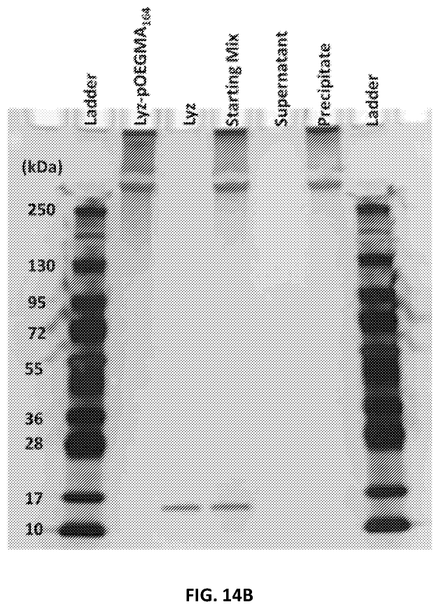

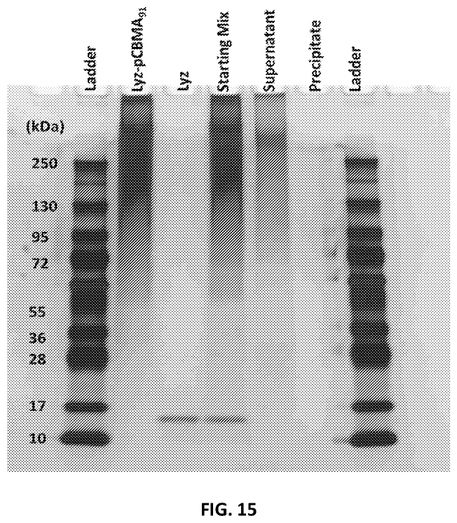

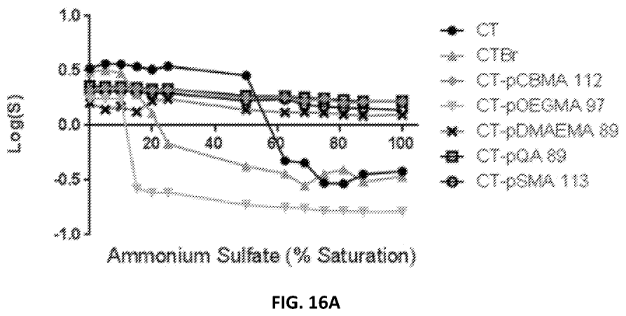

After verifying that ammonium sulfate did not deactivate the conjugates, the differences in solubilities were utilized to purify a mixture of conjugates and minute amounts of native Lyz (10 μg/mL). A hurdle in protein-polymer conjugate synthesis and characterization is heterogeneity. This makes characterization difficult (Russell et al., supra), and also impedes accurate measurements of activity and stability since unmodified protein may remain in the sample. Various chromatography techniques can be used to purify conjugates, including size exclusion, ion exchange, and high performance reverse phase chromatography, all of which require instrumentation and user-knowledge. Ammonium sulfate, however, is inexpensive and does not require high-end analytical equipment. Thus, long chained pCBMA and pOEGMA conjugates were mixed with native Lyz in a 1:99 volume ratio of native Lyz to conjugate (5 initiators), one of the species was preferentially precipitated, and SDS-PAGE analysis of the supernatant and precipitate was performed. Native Lyz and Lyz-pOEGMA DP 164 precipitated around 60% and 15%, respectively, while Lyz-pCBMA DP 91 did not precipitate at all. Therefore, to purify a mixture of native Lyz and Lyz-pOEGMA, ammonium sulfate was added at 40% saturation to preferentially precipitate the conjugate and to purify a mixture of native Lyz and Lyz-pCBMA, ammonium sulfate was added at 100% saturation to preferentially precipitate native Lyz. After preferential precipitation, samples were dialyzed in deionized water to remove the salt and then ultrafiltration was performed to obtain samples with the concentration of the starting mixture. Lyz(5+)pCBMA and Lyz(5+)pOEGMA gel lanes showed the typical band broadening after polymer conjugation and increases in molecular mass over native Lyz (FIGS. 14A and 14B). Both native Lyz and Lyz(5+)pCBMA were seen in the starting mixture, and after preferential precipitation, the band for native Lyz in the supernatant noticeably decreased (FIG. 14A). The gel was analyzed in ImageJ to compare the intensities of the native Lyz band before and after purification to estimate a final concentration of 0.003 mg/mL from a starting concentration of 0.01 mg/mL. A second round of preferential precipitation was performed on that supernatant and after another SDS-PAGE analysis, no native Lyz was detected in the supernatant (FIG. 15).

For Lyz(5+)pOEGMA, both the conjugate and native Lyz bands were seen in the starting mixture (FIG. 14B). After purification with 40% ammonium sulfate, the conjugate was preferentially precipitated and native Lyz was not detected in the precipitate, indicating successful purification. In addition, Image J was used to compare the band intensities of the conjugate in the starting mixture and the conjugate in the precipitate. The purification yield was estimated as 61%. Although there was a decrease in yield, the broadening of the band was decreased so that a more homogenous conjugate was purified. This method of purification based on differences in solubilities was very useful for conjugates of high modification where the salting out point was much different than the native protein. It is believed that this method can be utilized for other polymer types as well.

### Example 8

### Effect of Other Charged Polymers on Conjugate Solubility

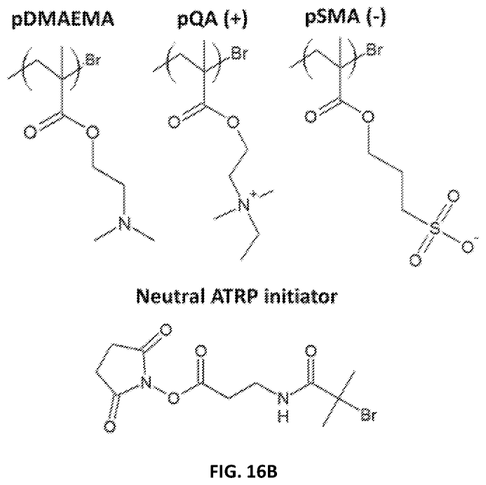

Finally, the range of conjugates for which purification by ammonium sulfate precipitation could be useful was examined. In particular, a-Chymotrypsin (CT)-polymer conjugates that were previously synthesized and characterized (Baker et al. 2018, supra) were studied. Briefly, twelve long-chained polymers of zwitterionic pCBMA (DP 112), neutral pOEGMA (DP 97), neutral/positive poly(dimethylaminoethyl methacrylate) (pDMAEMA) (DP 89), positively charged poly(quaternary ammonium methacrylate) (pQA) (DP 89), and negatively charged poly(sulfonate methacrylate) (pSMA) (DP 113) were grown from the surface of CT that had been modified with 12 neutral initiators, on average. Ammonium sulfate precipitation was performed on native CT, CT-initiator, and CT-polymer conjugates (FIG. 16A). Native CT precipitated near 60% saturation and CT-initiator precipitated around 20% saturation. This was much different than the case with Lyz, where native Lyz and Lyz-initiator precipitated around the same point. Lyz conjugates were synthesized with a positively charged initiator that preserved the positive charge previously on the amino group. CT conjugates, however, were synthesized with a neutral initiator such that covalent attachment converted the positively charged amino group to a non-ionizable amide bond, thereby increasing the negative to positive charge ratio on the local protein surface to increase hydrophobicity. This decrease in charge density caused the CT-initiator to precipitate at much lower ammonium sulfate concentrations. It also precipitated slowly over the range of 20 to 60% saturation, which again, could be potentially useful for sample fractionation to synthesize homogenous conjugates. Charged grafted-from initiators (Baker et al. 2019, supra) have been used, but the majority of grafted-from initiators that have been used are uncharged and target protein amino groups (Wilson, supra; Zhao et al., Polym. (United Kingdom) 66:A1-A10, 2015; and Grover and Maynard, Curr. Opin. Chem. Biol. 14:818-827, 2010). Therefore, the precipitation of protein-initiator before the native protein can be advantageous for separating unmodified from modified protein after the initiator reaction. As with Lyz, growth of pCBMA increased the solubility of CT up to 100% saturation, while growth of pOEGMA decreased solubility to 15% saturation. Interestingly, the positively charged pQA, positively charged pDMAEMA, and negatively charged pSMA conjugates all remained soluble up to 100% saturation as well. pDMAEMA has a pKa around 6.2 (Baker et al. 2018, supra), and at pH 7 would be 15% protonated and positively charged which was enough charge to keep CT soluble. Typical polyelectrolyte polymers collapse in high salt concentrations by screening of electrostatic interactions, but remain hydrated, which would have prevented precipitation (Higaki et al., Ind. Eng. Chem. Res. 57:4, 2018). There are many other types of monomers (both commercially available monomers and monomers and that can be synthesized in-house) that are amenable to grafting from techniques, namely ATRP or reversible addition-fragmentation chain-transfer (RAFT) polymerization. Therefore, polymers can be specifically designed to tune the solubility of a protein-polymer conjugate to ease purification.

Overall, covalent attachment of polymers to a protein can significantly alter the protein's solubility, which can be tuned by changing the polymer type, grafting density, and polymer length. The grafting-from approach to conjugate synthesis easily allows for each of those variables to be tuned independently. Highly charged polymers (zwitterionic, positive, and negative) increase the solubility up to 100% ammonium sulfate saturation and prevent salting-out, while uncharged, amphiphilic polymers decrease solubility. Zwitterionic polymer conjugates that are soluble in 100% ammonium sulfate remain active and are stable for at least 2.5 months of storage. Experimental and simulation results showed that zwitterionic polymers, when bound to the protein surface, display the anti-polyelectrolyte effect with increasing salt concentration similar to the behavior of unbound zwitterionic polymers in salt solutions. Due to this effect, the conjugates are highly solvated at high ammonium sulfate concentrations. The differences in solubilities between conjugates and either native protein or protein-initiator can be utilized for simple purification and fractionation of heterogeneous mixtures.

The protein-polymer conjugates that were soluble in 100% ammonium sulfate (4.1 M) would fall into the category of extreme halophilic proteins that are able to survive in the harshest of salt conditions which further shows how polymer conjugation can increase the robustness of a protein to survive in non-native environments. The addition of ammonium sulfate to a protein solution can have many uses since it is kosmotropic and promotes stabilization. In general, polymer conjugation to a protein can cause structural changes and deactivation of the protein. Since ammonium sulfate has been shown to help refold misfolded/unfolded proteins, it could also be used to re-structure protein-polymer conjugates or help maintain the protein structure (prevent unfolding) throughout conjugate synthesis (initiator attachment and polymer growth). Additionally, polymer attachment has been shown to increase the thermostability of a protein. Ammonium sulfate has also been shown to increase a protein's thermostability. Therefore, the addition of ammonium sulfate to a protein-polymer conjugate solution could potentially increase the thermostability of a protein beyond the increase provided by the polymer. Another potential application is in the purification of a target protein from cell lysate, enabled through the use of non-natural amino acids. The target protein can be genetically engineered with a specific reactive group on a non-natural amino acid. Zwitterionic polymers can then by reacted to (or grown from) the non-natural amino acid followed by ammonium sulfate precipitation. The target protein will remain soluble while all other cell lysate contaminants will precipitate. The non-natural amino acid can also be engineered to contain a reversible/cleavable group so that the zwitterionic polymer can be cleaved after purification to yield the native target protein. This approach could have significant impact in antibody purification as an alternative to Protein A chromatography. In general, these studies demonstrated the ability to keep proteins soluble in high concentrations of salts by polymer conjugation, which can be utilized for many applications.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A protein-polymer conjugate, wherein the conjugate comprises a protein having one or more polymer chains attached thereto, wherein the polymer is a charged, zwitterionic, or polyelectrolyte polymer, and wherein the protein-polymer conjugate is soluble in saturated ammonium sulfate.

2-4. (canceled)

5. The protein-polymer conjugate of claim 1, wherein the saturated ammonium sulfate comprises ammonium sulfate at a concentration of about 4.0 to about 4.5 M.

6. The protein-polymer conjugate of claim 1, wherein the conjugate has a grafting density of 1 to 30 polymer chains per protein molecule.

7. The protein-polymer conjugate of claim 1, wherein the polymer comprises from two to 500 monomer units.

8. The protein-polymer conjugate of claim 1, wherein the protein retains function at a level that is at least 50% of the level of function when the protein is not conjugated to the polymer.

9. A saturated ammonium sulfate solution having the protein-polymer conjugate of claim 1 dissolved therein.

10. (canceled)

11. The saturated ammonium sulfate solution of claim 9, wherein the solution comprises ammonium sulfate at a concentration of about 4.0 to about 4.5 M.

12. (canceled)

13. A method for engineering the solubility of a protein, the method comprising:
selecting a polymer likely to confer high or low solubility in a saturated ammonium sulfate solution, wherein the polymer is a charged, zwitterionic, or polyelectrolyte polymer selected to confer high solubility in saturated ammonium sulfate or wherein the polymer is an uncharged polymer selected to confer low solubility in saturated ammonium sulfate, and
generating one or more chains of the selected polymer on the protein.

14. The method of claim 13, wherein the polymer is a charged polymer, a zwitterionic polymer, or a polyelectrolyte polymer.

15-16. (canceled)

17. The method of claim 13, wherein the polymer is an uncharged polymer is selected from the group consisting of poly(oligo(ethylene glycol) methacrylate) (pOEGMA), polyethylene glycol (PEG), pDMAEMA (polydimethylamino ethyl methacrylate), polyacrylamide, and polyvinyl pyrrolidone.

18. The method of claim 13, wherein the saturated ammonium sulfate solution comprises ammonium sulfate at a concentration of about 4.0 to about 4.5 M.

19. The method of claim 13, wherein the conjugate has a grafting density of 1 to 5 polymer chains per protein molecule.

20. The method of claim 13, wherein each chain of the selected polymer generated on the protein comprises from two to 500 monomer units.

21. The method of claim 13, wherein the generating comprises atom transfer radical polymerization (ATRP) or reversible addition fragmentation chain-transfer (RAFT) polymerization.

22. A method for generating a protein-polymer conjugate, the method comprising:
selecting a polymer likely to confer high or low solubility to the protein in saturated ammonium sulfate,
generating one or more chains of the selected polymer on the protein to yield the protein-polymer conjugate, and
placing the protein-polymer conjugate in a saturated ammonium sulfate solution.

23. The method of claim 22, wherein the polymer is a charged polymer, a zwitterionic polymer, or a polyelectrolyte polymer.

24-25. (canceled)

26. The method of claim 22, wherein the polymer is an uncharged polymer.

27. The method of claim 22, wherein the saturated ammonium sulfate comprises ammonium sulfate at a concentration of about 4.0 to about 4.5 M.

28. The method of claim 22, wherein the conjugate has a grafting density of 1 to 5 polymer chains per protein molecule.

29. The method of claim 22, wherein each chain of the selected polymer generated on the protein comprises from two to 500 monomer units.

30-37. (canceled)
